SEQUENCE LISTING (3 sequences)

SEQ ID NO: 1 - DNA, 52 bp, synthetic construct
  source 1..52: mol_type = other DNA
tcgtcggcagcgtcagatgtgtataagagacaggtgccagcmgccgcggtaa

SEQ ID NO: 2 - DNA, 54 bp, synthetic construct
  source 1..54: mol_type = other DNA
gtctcgtgggctcggagatgtgtataagagacagggactachvgggtwtctaat

SEQ ID NO: 3 - protein, 888 aa, Bifidobacterium bifidum
GDGDTSKDDWLWYKQPASQTDATATAGGNYGNPDNNRWQQTTLPFGNGKIGGTVWGEVSRERVTFNEETLWTGGPGSSTSYNGGNNETKGQNGATLRALNKQLANGAETVNPGNLTGGENAAEQGNYLNWGDIYLDYGFNDTTVTEYRRDLNLSKGKADVTFKHDGVTYTREYFASNPDNVMVARLTASKAGKLNFNVSMPTNTNYSKTGETTTVKGDTLTVKGALGNNGLLYNSQIKVVLDNGEGTLSEGSDGASLKVSDAKAVTLYIAAATDYKQKYPSYRTGETAAEVNTRVAKVVQDAANKGYTAVKKAHIDDHSAIYDRVKIDLGQSGHSSDGAVATDALLKAYQRGSATTAQKRELETLVYKYGRYLTIGSSRENSQLPSNLQGIWSVTAGDNAHGNTPWGSDFHMNVNLQMNYWPTYSANMGELAEPLIEYVEGLVKPGRVTAKVYAGAETTNPETTPIGEGEGYMAHTENTAYGWTAPGQSFSWGWSPAAVPWILQNVYEAYEYSGDPALLDRVYALLKEESHFYVNYMLHKAGSSSGDRLTTGVAYSPEQGPLGTDGNTYESSLVWQMLNDAIEAAKAKGDPDGLVGNTTDCSADNWAKNDSGNFTDANANRSWSCAKSLLKPIEVGDSGQIKEWYFEGALGKKKDGSTISGYQADNQHRHMSHLLGLFPGDLITIDNSEYMDAAKTSLRYRCFKGNVLQSNTGWAIGQRINSWARTGDGNTTYQLVELQLKNAMYANLFDYHAPFQIDGNFGNTSGVDEMLLQSNSTFTDTAGKKYVNYTNILPALPDAWAGGSVSGLVARGNFTVGTTWKNGKATEVRLTSNKGKQAAVKITAGGAQNYEVKNGDTAVNAKVVTNADGASLLVFDTTAGTTYTITKK

(19) United States
(12) Patent Application Publication
(10) Pub. No.: US 2025/0325005 A1
(43) Pub. Date: Oct. 23, 2025

(54) FEED ADDITIVE COMPOSITIONS AND METHODS FOR USING THE SAME

(71) Applicant: INTERNATIONAL N&H DENMARK APS, Kongens Lyngby (DK)

(72) Inventors: Charlotte Horsmans POULSEN, Braband (DK); Jonathan PETERSON, Egg Harbor Township, NJ (US); Tanja Maria GRUBER, Media, PA (US)

(21) Appl. No.: 18/683,985

(22) PCT Filed: Aug. 22, 2022
(86) PCT No.: PCT/US2022/075279

§ 371 Date: Feb. 15, 2024

Related U.S. Application Data
(60) Provisional application No. 63/236,079, filed on Aug. 23, 2021.
(60) Provisional application No. 63/308,732, filed on Feb. 10, 2022.

(51) Int. Cl. A23K 20/189; A23K 50/30; A23K 50/60

(52) U.S. Cl. CPC A23K 20/189; A23K 50/30; A23K 50/60; C12Y 302/01051

(57) ABSTRACT

Provided herein, inter alia, are methods for improving animal health (such as gut health) and performance as well as decreasing methane emissions via administration of an effective amount of a glycoside hydrolase capable of removing at least one alpha-1,2-L-fucose moiety from an intestinal mucin layer. Such methods improve animal health and performance without the need to administer potentially harmful antibiotics to the livestock.

### CROSS-REFERENCE TO RELATED APPLICATIONS

This application is a U.S. National Phase application under 35 U.S.C. § 371 of International Patent Application No. PCT/US2022/075279, filed Aug. 22, 2022, which claims priority to U.S. Provisional Patent Application No. 63/236,079, filed Aug. 23, 2021 and to U.S. Provisional Patent Application No. 63/308,732, filed Feb. 10, 2022, the disclosure of each of which is incorporated by reference herein in its entirety.

### FIELD OF THE INVENTION

Provided herein, inter alia, are methods and compositions for promoting a beneficial gut microbiota in livestock animals via glycan engineering.

### BACKGROUND

The diverse and dynamic microbial community within the gastrointestinal tract of animals plays a key role in maintaining gut health and animal performance. The microbiota mediates nutrient utilization, development and maintenance of the immune system and provides colonization resistance against pathogens.

Antibiotic resistance is on the WHO's top ten list of threats to global human health in 2019, particularly in the context of large-scale farming and meat production. According to the U.S. Food and Drug Administration, 80% of antibiotics sold are used for livestock. In many countries, a ban on antibiotic use in livestock production has already been implemented and in others consumer pressure is forcing the industry to stop using antibiotic growth promoters. The abrupt cessation of the use of antibiotic growth promoters has put the livestock industry under high pressure. For example, swine producers in Latin America saw 2× mortality increase when shifting to antibiotic-free production. It is estimated that E. coli-caused diarrhea in piglets alone costs the industry $2.5 billion USD per year globally.

Current feed additives such as acidifiers, minerals, prebiotics, direct fed microbials (DFMs; a.k.a. probiotics), nucleotides, and plant extracts (Liu et al., 2018, Animal Nutrition, 4: 113-125)) to replace antibiotic growth promoters in livestock production all show a much lower efficacy (less than 50%) than antibiotics (ca 95%). There is, therefore, a large unmet need to find alternatives to antibiotics, which can maintain livestock health and performance without the accompanying negative effects associated with increased antibiotic resistance.

The subject matter disclosed herein addresses this need and provides additional benefits as well.

### SUMMARY

Provided herein, inter alia, are methods for improving animal health (such as gut health) and performance as well as decreasing methane emissions via administration of an effective amount of a glycoside hydrolase capable of removing at least one alpha-1,2-L-fucose moiety from an intestinal mucin layer. Such methods improve animal health and performance without the need to administer potentially harmful antibiotics to the livestock.

Accordingly, provided herein are methods for improving gut health in an animal comprising administering to the animal an effective amount of a glycoside hydrolase capable of removing at least one alpha-1,2-L-fucose moiety from an intestinal mucin layer. In some embodiments, improving gut health comprises one or more of a) promoting growth of one or more commensal intestinal bacterial; b) decreasing growth of one or more methanogenic archaea; c) increasing the quantity of intestinal IgA including, without limitation, intestinal IgA bound to fecal microbes; d) decreasing the quantity of intestinal neutrophil levels; e) increasing average daily feed intake (ADFI) of the animal; f) decreasing mortality; and/or g) improving feed conversion ratio (FCR). In some embodiments of any of the embodiments disclosed herein, the commensal bacteria comprise Prevotella spp., Megasphaera spp., Clostridium spp., Blautia spp., Ruminococcus spp., Desulfovibrio spp., and/or Barnesiella spp. In some embodiments of any of the embodiments disclosed herein, the methanogenic archaea comprise Methanobrevibacter spp., and/or Methanomassiliicoccus spp. In some embodiments, the methanogenic archaea comprise M. smithii. In some embodiments of any of the embodiments disclosed herein, the glycoside hydrolase is an alpha-L-fucosidase. In some embodiments, the alpha-L-1,2 fucosidase is selected from the group consisting of glycoside hydrolase family 95 (GH95) and glycoside hydrolase family 29 (GH 29). In some embodiments of any of the embodiments disclosed herein, the method further comprises administering to the animal an effective amount of at least one direct fed microbial. In some embodiments of any of the embodiments disclosed herein, the method further comprises administering to the animal an effective amount of one or more additional enzyme selected from the group consisting of protease, xylanase, beta-glucanase, phytase, and amylase. In some embodiments of any of the embodiments disclosed herein, the alpha-L-1,2 fucosidase and/or additional enzyme is encapsulated. In some embodiments of any of the embodiments disclosed herein, the alpha-L-1,2 fucosidase and/or the direct fed microbial and/or the additional enzyme are administered in an animal feed or a premix. In some embodiments of any of the embodiments disclosed herein, the alpha-L-1,2 fucosidase and/or additional enzyme is in the form of a granule. In some embodiments of any of the embodiments disclosed herein, the animal is swine. In some embodiments of any of the embodiments disclosed herein, the swine is a piglet, a growing pig, or a sow. In some embodiments, the piglet is a newly-weaned piglet. In some embodiments of any of the embodiments disclosed herein, the glycoside hydrolase capable of removing at least one alpha-1,2-L-fucose moiety from an intestinal mucin layer is not administered for treatment or prevention of intestinal pathogenic infection and/or diarrhea. In some embodiments of any of the embodiments disclosed herein, the glycoside hydrolase capable of removing at least one alpha-1,2-L-fucose moiety from an intestinal mucin layer is administered for at least 3 weeks. In some embodiments of any of the embodiment disclosed herein, the intestinal IgA is bound to fecal microbes. In some embodiments of any of the embodiment disclosed herein, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In another aspect, also provided herein are methods for decreasing methane emissions in an animal comprising administering to the animal an effective amount of a glycoside hydrolase capable of removing at least one alpha-1,2-L-fucose moiety from an intestinal mucin layer. In some embodiments, the decreased methane emissions result from decreased growth of one or more methanogenic archaea in the intestinal tract if the animal. In some embodiments of any of the embodiments disclosed herein, the methanogenic archaea comprises Methanobrevibacter spp., and/or Methanomassiliicoccus spp. In some embodiments of any of the embodiments disclosed herein, the methanogenic archaea comprises M. smithii. In some embodiments of any of the embodiments disclosed herein, the glycoside hydrolase is an alpha-L-fucosidase. In some embodiments, the alpha-L-1,2 fucosidase is selected from the group consisting of glycoside hydrolase family 95 (GH95) and glycoside hydrolase family 29 (GH 29). In some embodiments of any of the embodiments disclosed herein, the alpha-L-1,2 fucosidase is encapsulated. In some embodiments of any of the embodiments disclosed herein, the alpha-L-1,2 fucosidase is in an animal feed or a premix. In some embodiments of any of the embodiments disclosed herein, the alpha-L-1,2 fucosidase is in the form of a granule. In some embodiments of any of the embodiments disclosed herein, the animal is swine. In some embodiments of any of the embodiments disclosed herein, the swine is a piglet, a growing pig, or a sow. In some embodiments, the piglet is a newly-weaned piglet. In some embodiments of any of the embodiments disclosed herein, the glycoside hydrolase capable of removing at least one alpha-1,2-L-fucose moiety from an intestinal mucin layer is administered for at least 3 weeks. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

Each of the aspects and embodiments described herein are capable of being used together, unless excluded either explicitly or clearly from the context of the embodiment or aspect.

Throughout this specification, various patents, patent applications and other types of publications (e.g., journal articles, electronic database entries, etc.) are referenced. The disclosure of all patents, patent applications, and other publications cited herein are hereby incorporated by reference in their entirety for all purposes.

### BRIEF DESCRIPTION OF THE DRAWINGS

FIG. 1 depicts a graph showing mean absolute Neutrophil cell counts, K/μL by treatment group and plotted by time on the x axis: (day (−7), day 0, day 2, day 5, and day 14). Treatment group A (No fucosidase)=circles, treatment group B (50 mg/kg fucosidase)=crosses, treatment group C (100 mg/kg fucosidase)=diamonds, treatment group D (200 mg/kg fucosidase)=X.

FIG. 2 depicts a series of graphs showing mean fluorescent intensity of IgA bound to fecal microbes measured by flow cytometry for day 0, day 5 and day 14, respectively and grouped by treatment, within the respective days. Fucosidase concentration (FC)=0, 50, 100, or 200 mg enzyme per kg feed. Statistical analysis was determined using a Welch's ANOVA followed by Dunnett's T3 post hoc test to determine pairwise significance between groups denoted by asterisks (*P<0.05-0.01, **P<0.01-0.001, ***P<0.001).

FIG. 3 depicts a series of graphs showing relative abundance of Desulfovibrio piger (FIG. 3A) and Methanobrevibacter smithii (FIG. 3B) measured in day 0 fecal samples by 16s Illumina sequencing. Data are grouped by treatment group where treatment values are measured as mg enzyme per kg feed. Kruskal-Wallis with Dunn's corrections were used for group comparisons where ***=P<0.0001. FIG. 3C depicts an xy scatterplot showing relative abundance values in DO values between D. piger and M. smithii.

FIG. 4 depicts microbial abundance measured from amplicon sequencing of 16S rRNA from DO fecal metagenomic extracts. Prevotella species abundance data grouped by fucosidase treatment (mg per kg feed). Kruskal-Wallis tests for treatment group effects were significant for P. copri (ρ=0.008), P. copri 96% (ρ=0.002), and P. stercorea (ρ=0.008). Dunn's corrections were used for group comparisons where **=P<0.001.

FIG. 5 depicts a series of graphs showing complete blood count measurements obtained from individual animals on day 0 analyzed for treatment group differences using one-way ANOVA. Percent neutrophil and percent lymphocyte counts were plotted by group and pairwise comparisons that were significantly different p<(0.05−0.02)=*, p<0.01**. Neutrophil/lymphocyte ratios (NLR) were calculated from absolute cell count values and plotted and analyzed as described for the percent values.

FIG. 6 is a plot depicting total sIgA levels (ng/mL) in the feces of fucosidase-treated piglets. Fucosidase was added into the feed at 100 ppm from day 0 till day 21. Fresh feces were collected from piglets on day 42 and frozen till use. PBS was added and the supernatant was used for total sIgA measurement. Each group represent 24 individual samples. Tr1: blank control; Tr2: fucosidase (WGW coated); Tr3: fucosidase (Eudragit coated). P<0.01.

### DETAILED DESCRIPTION

Prevotella is one of the most predominant genera of microbes within the large intestine of pigs. A meta-analysis including 20 studies (Holman et al., 2017, Host-Microbe Biology. mSystems 2:e00004-17) showed that, among fecal samples, the genera Prevotella, Clostridium, AlloPrevotella, Ruminococcus, and the RC9 gut group were found in 99% of all fecal samples. Additionally, Clostridium, Blautia, LactoBacillus, Prevotella, Ruminococcus, Roseburia, the RC9 gut group, and Subdoligranulum were shared by 90% of all GI samples, suggesting a so-called “core” microbiota for commercial swine worldwide. In addition, Prevotella was also the most abundant genera of microbes among all genera identified (Holman et al., 2017, Host-Microbe Biology. mSystems 2:e00004-17).

In commercial swine production, pigs are typically fed a cereal grain-based diet that is relatively high in carbohydrate content. Prevotella produce carbohydrases such as glucanase, mannanase, and xylanase (Holman et al., 2017, Host-Microbe Biology. mSystems 2:e00004-17). Clostridium, Blautia, and Ruminococcus are all members of the Clostridiales order, and, similarly to Prevotella, are widely found in the mammalian gut (Biddle et al., 2013, Diversity 5:627-640). These genera produce butyrate, a short-chain fatty acid (SCFA), most often from acetate (also an SCFA) via the butyryl-coenzyme A (CoA):acetate CoA-transferase pathway (Vital et al., 2014, mBio 5: e00889-14). Prevotella spp., which produce acetate in the gut, thereby provide a source of energy for butyrate-producing bacteria (Looft et al., 2014, Front Microbiol. 5:276). Importantly, butyrate decreases inflammation in the gut of the host, and cells in the intestinal epithelium can use it as an energy source (Hamer et al., 2008, Aliment Pharmacol Ther. 27:104-119).

Feed intake in pigs has been linked to certain taxa in the microbiome. In a study with commercial Duroc pigs, it was revealed that the animals that harbored a Prevotella-predominant enterotype had significantly higher average daily feed intake (ADFI). Further, it was shown that Prevotella was a hub bacterium in the co-abundance network that exhibited strong positive association with ADFI (Yang et al., 2018, BMC Microbiol. 2018, 18, 215).

It was thus speculated that Prevotella may promote feed intake in pigs, warranting further research into the manipulation of gut Prevotella species to enhance feed intake and thereby promote growth performance (Amat et al., 2020, Microorganisms, 8, 1584). It has since been shown that Fut −/− pigs (i.e., possessing an inactive transfucosylation enzyme) exhibited altered intestinal mucin glycosylation whereby mucins lacked alpha1,2 fucosylations (Hesselager, 2015, “The impact of alpha 1,2 fucosyltransferase 1 (FUT1) on pig gut health.” PhD thesis, Aarhus University, Aarhus, Denmark). These Fut −/− pigs had much lower levels of intestinal Prevotella species and exhibited growth reductions relative to wild type animals. This observation might have resulted in this genotype not being generally selected for swine breeding programs even though the Fut −/− genotype imparts resistance to infection with enterotoxigenic Escherichia coli (ETEC) F18.

The studies discussed above support the positive correlation between Prevotella and growth in swine and also suggest that Prevotella is dependent on fucose derived from intestinal mucin as an energy source to thrive in the gut. As suckling piglets transition to solid feed there is a shift in the abundance of microbial species from those adapted to milk oligosaccharides and host-derived glycans to microbes that can adapt to nutrients liberated from complex cereal based diets. Maturation of adaptive immunity in piglets relies on cues received from microbes that colonize the gut through the weaning process. Disruptions in immune development due to inflammation or establishment of microbial communities that do not support proper immune development can lead to acute mortality losses, permanent immune dysfunction, and performance losses.

The succession of microbial composition from an immature pre-weaned state to a mature state can take on many trajectories. Rapidly attaining a mature microbial composition dominated by certain core microbial species and the development of a robust adaptive immune system are mutually dependent processes that both occur in a developmentally chaotic window.

Based on the above-discussed criteria, Prevotella is a very strong candidate for a more efficient next generation probiotic for promoting the development of a mature gut microbiome in post-weaned livestock. Unfortunately, Prevotella spp. are gram-negative strict anaerobes, which are very difficult to grow, particularly at commercially significant quantities. In fact, it is currently difficult to simply isolate Prevotella (Amat et al, 2020, Microorganisms, 8, 1584), let alone deliver it to livestock as a feed component in an aerobic environment.

Fortunately, the inventors of the instant application have surprisingly found that enzymatic in situ modification of intestinal glycans in livestock (e.g., swine) can be an effective method to support adaptive immune system development and long-term performance by structuring microbial succession through the challenging transition from pre- to post-weaning. Specifically, it was found that when feeding a fucosidase to post-weaning piglets, there was an increase in the amount of Prevotella spp. in the gut microbiota. The inventors also observed a positive correlation between fucosidase treatment, gut IgA levels, average daily growth, mortality, and the populations of other potentially beneficial gut probiotics, for example, Megasphaera spp. The invention disclosed herein therefore provides a new way for promoting the growth of desired beneficial gut bacteria (e.g., Prevotella) in situ by selectively providing the bacteria with a food source (e.g., fucose) derived from the animal's own intestinal mucin via addition of glycan hydrolyzing enzymes (e.g., fucosidases) to feed. Moreover, the inventors also observed a decrease in the abundance of intestinal methanogenic archaea upon administration of fucosidase. Thus, in addition to promoting benefits associated with immune development and performance in animals, the methods described herein can also result in decreased methane production in livestock, thereby decreasing the overall environmental impact associated with large-scale animal production.

### I. Definitions

The term “glycoside hydrolase” is used interchangeably with “glycosidases” and “glycosyl hydrolases”. Glycoside hydrolases assist in the hydrolysis of glycosidic bonds in complex sugars (polysaccharides). Together with glycosyltransferases, glycosidases form the major catalytic machinery for the synthesis and breakage of glycosidic bonds. Glycoside hydrolases are classified into EC 3.2.1 as enzymes catalyzing the hydrolysis of glycosides. Glycoside hydrolases can also be classified according to the stereochemical outcome of the hydrolysis reaction: thus, they can be classified as either retaining or inverting enzymes. Glycoside hydrolases can also be classified as exo or endo acting, dependent upon whether they act at the (usually non-reducing) end or in the middle, respectively, of an oligo/polysaccharide chain. Glycoside hydrolases may also be classified by sequence or structure-based methods. They are typically named after the substrate that they act upon.

The term “glycosyltransferase” refers to an enzyme that catalyzes the formation of a glycosidic bond between saccharides.

The terms “alpha-L-fucosidase,” “alpha-L-fucoside fucohydrolase,” and “alpha-fucosidase” are used interchangeably herein and refer to an enzyme in the EC class No. 3.2.1.51 that removes an L-fucose from an alpha-L-fucoside. Alpha-L-fucosidases are exoglycosidases found in a variety of organisms and mammals. Alpha-L-fucosidases have been divided into two distinct glycoside hydrolase families: alpha-L-fucosidases that catalyze hydrolysis using a retaining mechanism belong to the well-known glycoside hydrolase family 29 (GH29). Alpha-L-fucosidases that catalyze hydrolysis using an inverting mechanism belong to the glycoside hydrolase family 95 (GH95).

The terms “alpha-1,2-L-fucosidase,” “Almond emulsin fucosidase II,” alpha-2-L-fucopyranosyl-beta-D-galactoside fucohydrolase,” and “alpha-(1->2)-L-fucosidase” are used interchangeably herein and refer to an enzyme in the EC class No. 3.2.1.63 that catalyzes the hydrolysis of non-reducing terminal L-fucose residues linked to D-galactose residues by a 1,2-alpha linkage. The terms “alpha-1,3-L-fucosidase,” “Almond emulsin fucosidase I,” and “alpha-3-L-fucose-N-acetylglucosaminyl-glycoprotein fucohydrolase” are used interchangeably herein and refer to an enzyme in the EC class No. 3.2.1.111 that hydrolyzes (1->3)-linkages between alpha-L-fucose and N-acetylglucosamine residues.

The terms “alpha-1,6-L-fucosidase,” “alpha-L-fucosidase,” and “1,6-L-fucose-N-acetyl-D-glucosaminylglycopeptide fucohydrolase” are used interchangeably herein refer to an enzyme in the EC class No. 3.2.1.127 that hydrolyzes (1->6)-linkages between alpha-L-fucose and N-acetyl-D-glucosamine residues.

The terms “defucosylate” and “defucosylating” are used interchangeably and refer to an enzyme capable of removing a fucosyl group from a glycan-containing structure.

The terms “glycan” and “polysaccharide” are used interchangeably herein. Glycan refers to a polysaccharide or oligosaccharide, or the carbohydrate section of a glycoconjugate such as a glycoprotein, a glycolipid, or a proteoglycan, even if the carbohydrate is only an oligosaccharide. Glycans may be homo- or heteropolymers of monosaccharide residues. They may be linear or branched molecules. Glycans can be found attached to proteins as in glycoproteins and proteoglycans. In general, they are found on the exterior surface of cells. O- and N-linked glycans are very common in eukaryotes but may also be found, although less commonly, in prokaryotes.

The term “glycan-containing structure” as used herein refers to any structure, such as proteins, lipids and the like to which a glycan can be attached in any manner.

The term “N-acetyl-galactosylamine-containing moiety” is a structure to which an N-acetyl-galacatosylamine is attached. Such structures include, but are not limited to, carbohydrates and the like.

“Mucin” or “mucins,” as used herein, refers to the glycan-peptides of mucus secreted from epithelial cells that form mucosal barrier to protect various tissues, such as the eyes, pancreas, intestine, exocrine glands, hepatobiliary, respiratory and reproductive tracts. There are approximately 20 different types of mucins known in the art, e.g. MUC 1, MUC 2, MUC 5AC and MUC 5B . . . etc. Typically, mucins form extremely large oligomers through linkage of glycoprotein monomers using disulfide bonds. Usually, such glycoproteins are large >100,000 Daltons and typically consist of approximately 75% carbohydrate and 25% protein. As used herein, mucins possess at least one L-fucose moiety.

As used herein, “fucose” refers to fucose in the common meaning, which is a type of deoxy sugar, 6-deoxy-galactose, with a chemical formula of C₆H₁₂O₅, molecular weight of 164.16, melting point of 163° C., and specific rotation of −76°, and classified as a hexose and monosaccharide. The L form is widely present in nature in animals (such as in intestinal mucin) and plants in the form of L-fucoside. The O form is also present in animals (for example, pigs; see Hesselager et al. 2016, Glycobiology, 26(6): 607-622). In mammals and plants, fucose is found on an N-linked sugar chain on a cell surface.

As used herein, an “effective amount” or a “therapeutically effective amount” is an amount that provides a nutritional, physiological, or medical benefit to an animal.

As used herein, “commensal” refers to a symbiotic relationship in which one species (such as an animal) is benefited while the other (such as a microorganism, such as a gut microorganism) is unaffected or an organism participating in a symbiotic relationship in which one species derives some benefit (such as an animal) while the other is unaffected (such as a microorganism, such as a gut microorganism). A “commensal bacteria” is a microorganism (such as a gut bacteria) that provides a benefit for a host (such as a monogastric animal). Non-limiting examples of commensal bacteria include Prevotella spp., Megasphaera spp., and Barnesiella spp.

As used herein, the term “methanogen” or “methanogenic archaea” refers to methane-producing organisms including both methane-producing bacteria and to Archaea (formerly classified as archaebacteria). The methanogenic pathways of all species of methanogens have in common the conversion of a methyl group to methane; however, the origin of the methyl group varies. Most species are capable of reducing carbon dioxide (CO₂) to a methyl group with either a molecular hydrogen (H₂) or formate as the reductant. Methane (CH₄) production pathways in methanogens that utilize CO₂ and H₂ involve specific methanogen enzymes, which catalyze unique reactions using unique coenzymes. In some embodiments, a methanogen is a Methanobrevibacter spp.

The term “animal” as used herein includes all non-ruminant (including humans) and ruminant animals. In a particular embodiment, the animal is a non-ruminant animal, such as a horse and a mono-gastric animal. Examples of mono-gastric animals include, but are not limited to, pigs and swine, such as piglets, growing pigs, sows; poultry such as turkeys, ducks, chicken, broiler chicks, layers; fish such as salmon, trout, tilapia, catfish and carps; and crustaceans such as shrimps and prawns. In a further embodiment the animal is a ruminant animal including, but not limited to, cattle, young calves, goats, sheep, giraffes, bison, moose, elk, yaks, water buffalo, deer, camels, alpacas, llamas, antelope, pronghorn and nilgai.

As used herein, the term “weaning” refers to the removal of young pigs (i.e. piglets) from a lactating sow. “Weaned” pigs are young pigs (i.e. piglets) that are no longer in contact with a lactating sow. The term “newly-weaned” refers to piglets that have recently (such as within 1, 2, 3, 4, 5, 6, 7, 8, 9, 10, 11, 12, 13, 14, 15, 16, 17, 18, 19, 20, or 21 days or more) been removed from a lactating sow.

The term “pathogen” as used herein means any causative agent of disease. Such causative agents can include, but are not limited to, bacterial, viral, fungal causative agents and the like.

A “feed” and a “food,” respectively, means any natural or artificial diet, meal or the like or components of such meals intended or suitable for being eaten, taken in, digested, by a non-human animal and a human being, respectively. As used herein, the term “food” is used in a broad sense—and covers food and food products for humans as well as food for non-human animals (i.e. a feed). The term “feed” is used with reference to products that are fed to animals in the rearing of livestock. The terms “feed” and “animal feed” are used interchangeably. In a preferred embodiment, the food or feed is for consumption by non-ruminants and ruminants.

As used herein, the term “feed conversion ratio” refers to the amount of feed fed to an animal to increase the weight of the animal by a specified amount. An improved feed conversion ratio means a lower feed conversion ratio. By “lower feed conversion ratio” or “improved feed conversion ratio” it is meant that the use of a fucosidase-containing feed additive composition, feed, or diet in feed results in a lower amount of feed being required to be fed to an animal to increase the weight of the animal by a specified amount compared to the amount of feed required to increase the weight of the animal by the same amount when the feed does not comprise said fucosidase-containing feed additive composition, feed, or diet.

The term “direct fed microbial” (“DFM”) as used herein is a source of live (viable) naturally occurring microorganisms. Categories of DFMs include Bacillus, Lactic Acid Bacteria and Yeasts. Bacillus are unique, gram-positive rods that form spores. These spores are very stable and can withstand environmental conditions such as heat, moisture and a range of pH. These spores germinate into active vegetative cells when ingested by an animal and can be used in meal and pelleted diets. Lactic Acid Bacteria are gram-positive cocci that produce lactic acid which are antagonistic to pathogens. Since Lactic Acid Bacteria appear to be somewhat heat-sensitive, they are not used in pelleted diets. Types of Lactic Acid Bacteria include Bifidobacterium, Lactobacillus and Streptococcus. Yeasts are not bacteria. These microorganisms belong to the plant group fungi.

The term “isolated” means a substance in a form or environment that does not occur in nature. Non-limiting examples of isolated substances include (1) any non-naturally occurring substance, (2) any substance including, but not limited to, any host cell, enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated.

The term “purified” as applied to nucleic acids or polypeptides generally denotes a nucleic acid or polypeptide that is essentially free from other components as determined by analytical techniques well known in the art (e.g., a purified polypeptide or polynucleotide forms a discrete band in an electrophoretic gel, chromatographic eluate, and/or a media subjected to density gradient centrifugation). For example, a nucleic acid or polypeptide that gives rise to essentially one band in an electrophoretic gel is “purified.” A purified nucleic acid or polypeptide is at least about 50% pure, usually at least about 60%, about 65%, about 70%, about 75%, about 80%, about 85%, about 90%, about 91%, about 92%, about 93%, about 94%, about 95%, about 96%, about 97%, about 98%, about 99%, about 99.5%, about 99.6%, about 99.7%, about 99.8% or more pure (e.g., percent by weight on a molar basis). In a related sense, a composition is enriched for a molecule when there is a substantial increase in the concentration of the molecule after application of a purification or enrichment technique.

The terms “peptides”, “proteins” and “polypeptides are used interchangeably herein and refer to a polymer of amino acids joined together by peptide bonds. A “protein” or “polypeptide” comprises a polymeric sequence of amino acid residues. The single and 3-letter code for amino acids as defined in conformity with the IUPAC-IUB Joint Commission on Biochemical Nomenclature (JCBN) is used throughout this disclosure. The single letter X refers to any of the twenty amino acids. It is also understood that a polypeptide may be coded for by more than one nucleotide sequence due to the degeneracy of the genetic code.

As used herein with regard to amino acid residue positions, “corresponding to” or “corresponds to” or “corresponds” refers to an amino acid residue at the enumerated position in a protein or peptide, or an amino acid residue that is analogous, homologous, or equivalent to an enumerated residue in a protein or peptide. As used herein, “corresponding region” generally refers to an analogous position in a related protein or a reference protein.

The terms “derived from” and “obtained from” refer to not only a protein produced or producible by a strain of the organism in question, but also a protein encoded by a DNA sequence isolated from such strain and produced in a host organism containing such DNA sequence. Additionally, the term refers to a protein which is encoded by a DNA sequence of synthetic and/or cDNA origin and which has the identifying characteristics of the protein in question.

The term “amino acid” refers to the basic chemical structural unit of a protein or polypeptide. Thus, a codon for the amino acid alanine, a hydrophobic amino acid, may be substituted by a codon encoding another less hydrophobic residue (such as glycine) or a more hydrophobic residue (such as valine, leucine, or isoleucine). Similarly, changes which result in substitution of one negatively charged residue for another (such as aspartic acid for glutamic acid) or one positively charged residue for another (such as lysine for arginine) can also be expected to produce a functionally equivalent product. In many cases, nucleotide changes which result in alteration of the N-terminal and C-terminal portions of the protein molecule would also not be expected to alter the activity of the protein. Each of the proposed modifications is well within the routine skill in the art, as is determination of retention of biological activity of the encoded products.

The term “codon optimized”, as it refers to genes or coding regions of nucleic acid molecules for transformation of various hosts, refers to the alteration of codons in the gene or coding regions of the nucleic acid molecules to reflect the typical codon usage of the host organism without altering the polypeptide for which the DNA codes.

The term “gene” refers to a nucleic acid molecule that expresses a specific protein, including regulatory sequences preceding (5′ non-coding sequences) and following (3′ non-coding sequences) the coding sequence. “Native gene” refers to a gene as found in nature with its own regulatory sequences. “Endogenous gene” refers to a native gene in its natural location in the genome of an organism. A “foreign” gene refers to a gene not normally found in the host organism, but that is introduced into the host organism by gene transfer. Foreign genes can comprise native genes inserted into a non-native organism, or chimeric genes. A “transgene” is a gene that has been introduced into the genome by a transformation procedure.

The term “coding sequence” refers to a nucleotide sequence which codes for a specific amino acid sequence. “Suitable regulatory sequences” refer to nucleotide sequences located upstream (5′ non-coding sequences), within, or downstream (3′ non-coding sequences) of a coding sequence, and which influence the transcription, RNA processing or stability, or translation of the associated coding sequence. Regulatory sequences may include promoters, translation leader sequences, RNA processing site, effector binding sites, and stem-loop structures.

The term “operably linked” refers to the association of nucleic acid sequences on a single nucleic acid molecule so that the function of one is affected by the other.

For example, a promoter is operably linked with a coding sequence when it is capable of affecting the expression of that coding sequence, i.e., the coding sequence is under the transcriptional control of the promoter. Coding sequences can be operably linked to regulatory sequences in sense or antisense orientation.

The term “transformation” as used herein refers to the transfer or introduction of a nucleic acid molecule into a host organism. The nucleic acid molecule may be introduced as a linear or circular form of DNA. The nucleic acid molecule may be a plasmid that replicates autonomously, or it may integrate into the genome of a production host. Production hosts containing the transformed nucleic acid are referred to as “transformed” or “recombinant” or “transgenic” organisms or “transformants”.

The term “recombinant” as used herein refers to an artificial combination of two otherwise separated segments of nucleic acid sequences, e.g., by chemical synthesis or by the manipulation of isolated segments of nucleic acids by genetic engineering techniques. For example, DNA in which one or more segments or genes have been inserted, either naturally or by laboratory manipulation, from a different molecule, from another part of the same molecule, or an artificial sequence, resulting in the introduction of a new sequence in a gene and subsequently in an organism. The terms “recombinant”, “transgenic”, “transformed”, “engineered” or “modified for exogenous gene expression” are used interchangeably herein.

The terms “recombinant construct”, “expression construct”, “recombinant expression construct” and “expression cassette” are used interchangeably herein. A recombinant construct comprises an artificial combination of nucleic acid fragments, e.g., regulatory and coding sequences that are not all found together in nature. For example, a construct may comprise regulatory sequences and coding sequences that are derived from different sources, or regulatory sequences and coding sequences derived from the same source but arranged in a manner different than that found in nature. Such a construct may be used by itself or may be used in conjunction with a vector. If a vector is used, then the choice of vector is dependent upon the method that will be used to transform host cells as is well known to those skilled in the art. For example, a plasmid vector can be used. The skilled artisan is well aware of the genetic elements that must be present on the vector in order to successfully transform, select and propagate host cells. The skilled artisan will also recognize that different independent transformation events may result in different levels and patterns of expression (Jones et al., (1985) EMBO J 4:2411-2418; De Almeida et al., (1989) Mol Gen Genetics 218:78-86), and thus that multiple events are typically screened in order to obtain lines displaying the desired expression level and pattern. Such screening may be accomplished standard molecular biological, biochemical, and other assays including Southern analysis of DNA, Northern analysis of mRNA expression, PCR, real time quantitative PCR (qPCR), reverse transcription PCR (RT-PCR), immunoblotting analysis of protein expression, enzyme or activity assays, and/or phenotypic analysis.

The terms “production host”, “host” and “host cell” are used interchangeably herein and refer to any organism, or cell thereof, whether human or non-human into which a recombinant construct can be stably or transiently introduced in order to express a gene. This term encompasses any progeny of a parent cell, which is not identical to the parent cell due to mutations that occur during propagation.

The term “percent identity” is a relationship between two or more polypeptide sequences or two or more polynucleotide sequences, as determined by comparing the sequences. In the art, “identity” also means the degree of sequence relatedness between polypeptide or polynucleotide sequences, as the case may be, as determined by the number of matching nucleotides or amino acids between strings of such sequences. “Identity” and “similarity” can be readily calculated by known methods, including but not limited to those described in: Computational Molecular Biology (Lesk, A. M., ed.) Oxford University Press, NY (1988); Biocomputing: Informatics and Genome Projects (Smith, D. W., ed.) Academic Press, NY (1993); Computer Analysis of Sequence Data, Part I (Griffin, A. M., and Griffin, H. G., eds.) Humana Press, NJ (1994); Sequence Analysis in Molecular Biology (von Heinje, G., ed.) Academic Press (1987); and Sequence Analysis Primer (Gribskov, M. and Devereux, J., eds.) Stockton Press, NY (1991). Methods to determine identity and similarity are codified in publicly available computer programs.

As used herein, “% identity” or percent identity” or “PID” refers to protein sequence identity. Percent identity may be determined using standard techniques known in the art. Useful algorithms include the BLAST algorithms (See, Altschul et al., J Mol Biol, 215:403-410, 1990; and Karlin and Altschul, Proc Natl Acad Sci USA, 90:5873-5787, 1993). The BLAST program uses several search parameters, most of which are set to the default values. The NCBI BLAST algorithm finds the most relevant sequences in terms of biological similarity but is not recommended for query sequences of less than 20 residues (Altschul et al., Nucleic Acids Res, 25:3389-3402, 1997; and Schaffer et al., Nucleic Acids Res, 29:2994-3005, 2001). Exemplary default BLAST parameters for a nucleic acid sequence searches include: Neighboring words threshold=11; E-value cutoff=10; Scoring Matrix=NUC.3.1 (match=1, mismatch=−3); Gap Opening=5; and Gap Extension=2. Exemplary default BLAST parameters for amino acid sequence searches include: Word size=3; E-value cutoff=10; Scoring Matrix=BLOSUM62; Gap Opening=11; and Gap extension=1. A percent (%) amino acid sequence identity value is determined by the number of matching identical residues divided by the total number of residues of the “reference” sequence including any gaps created by the program for optimal/maximum alignment. BLAST algorithms refer to the “reference” sequence as the “query” sequence.

As used herein, “homologous proteins” or “homologous enzymes” refers to proteins that have distinct similarity in primary, secondary, and/or tertiary structure. Protein homology can refer to the similarity in linear amino acid sequence when proteins are aligned. Homologous search of protein sequences can be done using BLASTP and PSI-BLAST from NCBI BLAST with threshold (E-value cut-off) at 0.001. (Altschul et al., Nucleic Acids Res 1997 Set 1; 25(17):3389-402). Using this information, proteins sequences can be grouped. A phylogenetic tree can be built using the amino acid sequences. Sequence alignments and percent identity calculations may be performed using the Megalign program of the LASERGENE bioinformatics computing suite (DNASTAR Inc., Madison, WI), the AlignX program of Vector NTI v. 7.0 (Informax, Inc., Bethesda, MD), or the EMBOSS Open Software Suite (EMBL-EBI; Rice et at., Trends in Genetics 16, (6):276-277 (2000)). Multiple alignment of the sequences can be performed using the CLUSTAL method (such as CLUSTALW; for example version 1.83) of alignment (Higgins and Sharp, CA BIOS, 5:151-153 (1989); Higgins et at., Nucleic Acids Res. 22:4673-4680 (1994); and Chenna et at., Nucleic Acids Res 31 (13):3497-500 (2003)), available from the European Molecular Biology Laboratory via the European Bioinformatics Institute) with the default parameters. Suitable parameters for CLUSTALW protein alignments include GAP Existence penalty=15, GAP extension=0.2, matrix=Gonnet (e.g., Gonnet250), protein ENDGAP=−1, protein GAPDIST=4, and KTUPLE=1. In one embodiment, a fast or slow alignment is used with the default settings where a slow alignment. Alternatively, the parameters using the CLUSTALW method (e.g., version 1.83) may be modified to also use KTUPLE=1, GAP PENALTY=10, GAP extension=1, matrix=BLOSUM (e.g., BLOSUM64), WINDOW=5, and TOP DIAGONALS SAVED=5.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number can be a number which, in the context in which it is presented, provides the substantial equivalent of the specifically recited number. For example, in connection with a numerical value, the term “about” refers to a range of −10% to +10% of the numerical value, unless the term is otherwise specifically defined in context.

As used herein, the singular terms “a,” “an,” and “the” include the plural reference unless the context clearly indicates otherwise.

It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

It is also noted that the term “consisting essentially of,” as used herein refers to a composition wherein the component(s) after the term is in the presence of other known component(s) in a total amount that is less than 30% by weight of the total composition and do not contribute to or interferes with the actions or activities of the component(s).

It is further noted that the term “comprising,” as used herein, means including, but not limited to, the component(s) after the term “comprising.” The component(s) after the term “comprising” are required or mandatory, but the composition comprising the component(s) can further include other non-mandatory or optional component(s).

It is also noted that the term “consisting of,” as used herein, means including, and limited to, the component(s) after the term “consisting of.” The component(s) after the term “consisting of” are therefore required or mandatory, and no other component(s) are present in the composition.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Unless defined otherwise herein, all technical and scientific terms used herein have the same meaning as commonly understood by one of ordinary skill in the art to which this invention pertains.

Other definitions of terms may appear throughout the specification.

### II. Compositions

### A. Glycoside Hydrolases

Within the scope of this disclosure are compositions for improving gut health in an animal comprising administering to the animal an effective amount of a glycoside hydrolase capable of removing at least one alpha-1,2-L-fucose moiety from an intestinal mucin layer. Improved gut health, in all aspects, includes, without limitation, one or more of promoting growth of one or more commensal intestinal bacterial; decreasing growth of one or more methanogenic archaea; increasing the quantity of intestinal IgA including, without limitation, intestinal IgA bound to fecal microbes; decreasing the quantity of intestinal neutrophil levels; increasing feed intake of the animal; and/or decreasing feed conversion ratio (FCR).

In all aspects disclosed herein, an alpha-L-fucosidase is capable of removing a terminal alpha-1,2-linked fucose group from a glycan-containing structure either alone or in combination with an enzyme capable of removing an N-acetyl-galactosylamine-containing moiety from a glycan-containing structure. This is discussed further in the Examples below.

Without being bound by theory, it is believed that hydrolysis of terminal alpha-1,2 linked-fucose from intestinal mucin promotes the growth of one or more commensal bacteria in the gut (for example, Prevotella). Any enzyme, such as a glycoside hydrolase, capable of removing at least one fucosyl moiety from intestinal mucin can be used. In one embodiment, alpha-L-fucosidase (such as an alpha-L-1,2 fucosidase) polypeptides can be used. Glycoside hydrolases, such as alpha-L-fucosidase polypeptides, of the present disclosure include isolated, recombinant, substantially pure, or non-naturally occurring polypeptides.

In some embodiments, alpha-L-fucosidase (such as an alpha-L-1,2 fucosidase) polypeptides are from the glycoside hydrolase family 95 (GH95) or the glycoside hydrolase family 29 (G29). Most preferably, such alpha-L-fucosidase polypeptides are in the GH95 family.

It may be desirable to engineer alpha-L-fucosidase so that it is stable at low pH and is also stable to pepsin. Suitable alpha-L-fucosidases (such as an alpha-L-1,2 fucosidase) can be derived from a variety of sources, such as from Arcanobacterium, Bacillus, Bacteroides, Corynebacterium, Streptococcus, Dictyostelium, Fusarium, Aspergillus, Bifidobacterium, Ignisphaera, Mahella, Cellulophaga, Rubinisphaera, Niastella, Haliscomenobacter, Rhodopirellula, Mycobacterium, Clostridium, Flavobacteriaceae, Ktedonobacter, Listeria, Paludibacter, Prunus, Propionibacterium, Ruminococcus, Thermotoga, Xanthomonas, and LactoBacillus. Examples of species from which alpha-L-fucosidase can be derived include Arcanobacterium haemolyticum, Bacillus cereus, Bacillus thuringiensis, Bacillus sp. TS-2, Bacillus bataviensis, Bacillus niacini, Bacillus sp. J13, Bacillus sp. J37, Bacillus lehensis, Bacillus halodurans, Bacillus alcalophilus, Bacillus megaterium, Bacillus cellulosilyticus, Bacillus hemicellulosilyticus, Bacillus okuhidensis, Bacillus butanolivorans, Bacillus pseudalcaliphilus, Bacillus bogoriensis, Bacillus akibai, Bacillus fulminans, Bacteroides fragilis, Bacteroides helcogenes, Streptococcus mitis B6, Streptococcus pneumoniae, Dictostelium discoideum, Flavobacteriaceae bacterium 585, Fusarium graminearum, Aspergillus niger, Bifidobacterium bifidum, Bifidobacterium longum, Ignispheaera aggregans, Mahella australiensis, Cellulophaga lytica, Cellulophaga algicola, Rubinisphaera brasinliensis, Niastella koreensis, Haliscomenobacter hydrossis, Mycobacterium tuberculosis, Clostridium perfringens, Ktedonobacter racemifer, Listeria monocytogenes, Paludibacter propionicigenes, Prunus dulcis, Prop/on/bacterium acnes, Ruminococcus gnavus, Ruminococcus torques, Thermotoga maritima, Lactobacillus paracasei, Lactobacillus casei.

In still other embodiment, any alpha-L-fucosidases (such as an alpha-L-1,2 fucosidase) can be used to practice the methods and compositions disclosed herein. For examples, polypeptides having a fucosidase activity can be derived from Arcanobacterium haemolyticum, Bacillus cereus, Bacillus thuringiensis, Bacillus sp. TS-2, Bacillus bataviensis, Bacillus niacini, Bacillus sp. J13, Bacillus sp. J37, Bacillus lehensis, Bacillus halodurans, Bacillus alcalophilus, Bacillus megaterium, Bacillus cellulosilyticus, Bacillus hemicellulosilyticus, Bacillus okuhidensis, Bacillus butanolivorans, Bacillus pseudalcaliphilus, Bacillus bogoriensis, Bacillus akibai, Bacillus fulminans, Bacteroides fragilis, Bacteroides helcogenes, Streptococcus mitis B6, Streptococcus pneumoniae, Flavobacteriaceae bacterium S85, Fusarium graminearum, Aspergillus niger, Bifidobacterium bifidum, Bifidobacterium longum, Ignispheaera aggregans, Mahella australiensis, Cellulophaga lytica, Cellulophaga algicola, Rubinisphaera brasinliensis, Niastella koreensis, Haliscomenobacter hydrossis, Mycobacterium tuberculosis, Clostridium perfringens, Ktedonobacter racemifer, Listeria monocytogenes, Paludibacter propionicigenes, Prunus dulcis, Proprionbacterium acnes, Ruminococcus gnavus, Ruminococcus torques, Thermotoga maritima, Lactobacillus paracasei, Lactobacillus casei and Xanthomonas manihotis, or a sequence having at least 10%, 20%, 30%, 40%, 50%, 60%, 70%, 75%, 80%, 90%, 95%, 98%, 99% identity to the fucosidase sequence from Arcanobacterium haemolyticum, Bacillus cereus, Bacillus thuringiensis, Bacillus sp. TS-2, Bacillus bataviensis, Bacillus niacini, Bacillus sp. J13, Bacillus sp. J37, Bacillus lehensis, Bacillus halodurans, Bacillus alcalophilus, Bacillus megaterium, Bacillus cellulosilyticus, Bacillus hemicellulosilyticus, Bacillus okuhidensis, Bacillus butanolivorans, Bacillus pseudalcaliphilus, Bacillus bogoriensis, Bacillus akibai, Bacillus fulminans, Bacteroides fragilis, Bacteroides helcogenes, Streptococcus mitis B6, Streptococcus pneumoniae, Dictyostelium discoideum, Flavobacteriaceae bacterium S85, Fusarium graminearum, Aspergillus niger, Bifidobacterium bifidum, Bifidobacterium longum, Ignispheaera aggregans, Mahella australiensis, Cellulophaga lytica, Cellulophaga algicola, Rubinisphaera brasinliensis, Niastella koreensis, Haliscomenobacter hydrossis, Mycobacterium tuberculosis, Clostridium perfringens, Ktedonobacter racemifer, Listeria monocytogenes, Paludibacter propionicigenes, Prunus dulcis, Proprionbacterium acnes, Ruminococcus gnavus, Ruminococcus torques, Thermotoga maritima, Lactobacillus paracasei, Lactobacillus casei and Xanthomonas, or a polypeptide which differs from any of the above mentioned sequences by one or several amino acid additions, deletions and/or substitutions; or a polynucleotide which expresses any of the above fucosidase sequences.

In some embodiments, the glycoside hydrolase comprises a polypeptide at least about 60% identical (such as about 60%, 6%1, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97% 98%, 99%, or 100% identical (i.e. sharing percent sequence identity), inclusive of values in between these percentages) to the glycoside hydrolase encoded by SEQ ID NO:3.

Homology between two amino acid sequences can be determined by amino acid sequence alignment, e.g., using a program such as BLAST, ALIGN, or CLUSTAL, as described herein. In some embodiments, the polypeptide is an isolated, recombinant, substantially pure, or non-naturally occurring enzyme that is capable of removing, at a minimum, at least one fucosyl moiety.

Preferably, the enzyme has alpha-L-fucosidase activity, or catalyzes the cleavage of a terminal alpha-1,2-linked fucose group from a polysaccharide such as an alpha-L-fucoside.

It will be apparent to the skilled person that full length and/or mature alpha-L-fucosidase can be made using any well-known technique in the art.

### B. Nucleic Acids and Vectors

In another aspect any isolated, recombinant, substantially pure, synthetically derived, or non-naturally occurring nucleic acid comprising a nucleotide sequence encoding any polypeptide (including any fusion protein, etc.) that is capable of removing, at a minimum, at least one fucosyl moiety from an intestinal mucin.

Also, of interest is a vector comprising a polynucleotide encoding a glucose hydrolase such as an alpha-L-fucosidase (such as an alpha-L-1,2 fucosidase) enzyme which hydrolyzes an L-fucose moiety from an alpha-1,2-L-fucoside. It will be apparent to the skilled person that the vector can be any suitable expression vector and that the choice of vector may vary depending upon the type of cell into which the vector is to be inserted. Suitable vectors include pGAPT-PG, pRAX1, pGAMD, pGPT-pyrG1, pC194, pJH101, pE194, and pHP13 (See, Harwood and Cutting [eds.], Chapter 3, Molecular Biological Methods for Bacillus, John Wiley & Sons [1990]). See also, Perego, Integrational Vectors for Genetic Manipulations in Bacillus subtilis, in Sonenshein et al., [eds.]Bacillus subtilis and Other Gram-Positive Bacteria: Biochemistry, Physiology and Molecular Genetics, American Society for Microbiology, Washington, D.C. [1993], pp. 615-624), and p2JM103BBI.

The expression vector can be one of any number of vectors or cassettes useful for the transformation of suitable production hosts known in the art. Typically, the vector or cassette will include sequences directing transcription and translation of the relevant gene, a selectable marker, and sequences allowing autonomous replication or chromosomal integration. Suitable vectors generally include a region 5′ of the gene which harbors transcriptional initiation controls and a region 3′ of the DNA fragment which controls transcriptional termination. Both control regions can be derived from homologous genes to genes of a transformed production host cell and/or genes native to the production host, although such control regions need not be so derived.

DNA fragments which control transcriptional termination may also be derived from various genes native to a preferred production host cell. In certain embodiments, the inclusion of a termination control region is optional. In certain embodiments, the expression vector includes a termination control region derived from the preferred host cell.

The expression vector can be included in the production host, particularly in the cells of microbial production hosts. The production host cells can be microbial hosts found within the fungal or bacterial families and which grow over a wide range of temperature, pH values, and solvent tolerances. For example, it is contemplated that any of bacteria, algae, and fungi such as filamentous fungi and yeast may suitably host the expression vector.

Inclusion of the expression vector in the production host cell may be used to express the protein of interest so that it may reside intracellularly, extracellularly, or a combination of both inside and outside the cell. Extracellular expression renders recovery of the desired protein from a fermentation product more facile than methods for recovery of protein produced by intracellular expression.

The recombinant expression vector may be any vector such as a plasmid or virus which can conveniently be subjected to recombinant DNA procedures and lead to expression of the nucleotide sequence. The vector choice will typically depend on the compatibility of the vector with the production host into which the vector is to be introduced. The vectors may be linear or closed circular plasmids. The vector may be an autonomously replicating vector, i.e., a vector, which exists as an extrachromosomal entity, the replication of which is independent of chromosomal replication, e.g., a plasmid, an extrachromosomal element, a minichromosome, or an artificial chromosome. The vector may contain any means for assuring self-replication.

Alternatively, the vector may be one which, when introduced into the production host, is integrated into the genome and replicated together with the chromosome(s) into which it has been integrated. Some non-limiting examples of such vectors is provided in the Fungal Genetics Stock Center Catalogue of Strains (FGSC, <www.fgsc.net), Additional examples of suitable expression and/or integration vectors are provided in Sambrook et al., (1989) supra, Ausubel (1987) supra, van den Hondel et al. (1991) in Bennett and Lasure (Eds.) MORE GENE MANIPULATIONS IN FUNGI, Academic Press. 396-428 and U.S. Pat. No. 5,874,276.

Particularly useful vectors include pTREX, pFB6, pBR322, PUCI8, pUCIO0 and pENTR/D. Suitable plasmids for use in bacterial cells include pBR322 and pUC19 permitting replication in E. coli and pE194 for example permitting replication in Bacillus. Briefly with respect to production in production host cells reference can be made to Sambrook et al., (1989) supra, Ausubel (1987) supra, van den Hondel et al. (1991) in Bennett and Lasure (Eds.) MORE GENE MANIPULATIONS IN FUNGI, Academic Press (1991) pp. 76 and 396-428; Nunberg et al., (1984) Mol. Cell Biol. 4:2306-2315; Boel et al., (1984) 30 EMBO 1 3:1581-1585; Finkelstein in BIOTECHNOLOGY OF FILAMENTOUS FUNGI, Finkelstein et al. Eds. Butterworth-Heinemann, Boston, MA (1992), Chap. 6; Kinghorn et al. (1992) APPLIED MOLECULAR GENETICS OF FILAMENTOUS FUNGI, Blackie Academic and Professional, Chapman and Hall, London; Kelley et al., (1985) EMBO 1 4:475-479; Penttila et al., (1987) Gene 61: 155-164; and U.S. Pat. No. 5,874,276.

A list of suitable vectors may be found in the Fungal Genetics Stock Center Catalogue of Strains (FGSC, www at fgsc.net). Suitable vectors include those obtained from for example Invitrogen Life Technologies and Promega. Specific vectors suitable for use in fungal host cells include vectors such as pFB6, pBR322, pUC 18, pUC100, pDONTm201, pDONRTm221, pENTRTm, pGEM(D3Z and pGEM(D4Z.

The vector system may be a single vector or plasmid or two or more vectors or plasmids which together contain the total DNA to be introduced into the genome of the host cell, or a transposon.

The vector may also contain one or more selectable markers to permit easy selection of the transformed cells. A selectable marker is a gene, the product of which provides for biocide or viral resistance and the like. Examples of selectable markers include ones which confer antimicrobial resistance. Nutritional markers also find use in the present invention including those markers known in the art as amdS, argB and pyr4. Markers useful for the transformation of Trichoderma are known in the art (see, e.g., Finkelstein, chapter 6, in Biotechnology of Filamentous Fungi, Finkelstein et al., EDS Butterworth-Heinemann, Boston MA (1992) and Kinghorn et al., (1992) Applied Molecular Genetics of Filamentous Fungi, Blackie Academic and Professional, Chapman and Hall, London). In some embodiments, the expression vectors will also include a replicon, a gene encoding antibiotic resistance to permit selection of bacteria that harbor recombinant plasmids, and unique restriction sites in nonessential regions of the plasmid to allow insertion of heterologous sequences. The particular antibiotic resistance gene chosen is not critical; any of the many resistance genes known in the art are suitable. The prokaryotic sequences are preferably chosen such that they do not interfere with the replication or integration of the DNA in Trichoderma reesei.

The vector may also contain an element(s) permitting stable integration of the vector into the product host genome or autonomous replication of the vector in the production host independent of the genome of the cell. For integration into the host cell genome, the vector may rely on the nucleotide sequence encoding the aspartic protease or any other element of the vector for stable integration of the vector into the genome by homologous or nonhomologous recombination.

For autonomous replication, the vector may further comprise an origin of replication enabling the vector to replicate autonomously in the production host.

More than one copy of the nucleotide sequence encoding an alpha-L-fucosidase (such as an alpha-L-1,2 fucosidase) may be inserted into the production host to increase production of the alpha-L-fucosidase. An increase in the copy number of the nucleotide sequence can be obtained by integrating at least one additional copy of the sequence into the genome of the production host or by including an amplifiable selectable marker gene, and thereby additional copies of the nucleotide sequence can be selected for by culturing the production host cells in the presence of an appropriate selectable agent.

A vector comprising the nucleotide sequence encoding an alpha-L-fucosidase (such as an alpha-L-1,2 fucosidase) is introduced into the production host so that the vector is maintained as a chromosomal integrant or as a self-replicating extra-chromosomal vector. Integration is generally considered to be an advantage as the nucleotide sequence is more likely to be stably maintained in the production host.

Integration of the vector into the production host chromosome may occur by homologous or non-homologous recombination as was discussed above.

Exemplary vectors include, but are not limited to, pGXT (the same as the pTTTpyr2 vector as described in published PCT application WO2015/017256). There can also be mentioned standard bacterial expression vectors including bacteriophages X and M13, as well as plasmids such as pBR322 based plasmids, pSKF, pET23D, and fusion expression systems such as MBP, GST, and LacZ. Epitope tags can also be added to recombinant proteins to provide convenient methods of isolation, e.g., c-myc. Examples of suitable expression and/or integration vectors are provided in Sambrook et al., (1989) supra, Bennett and Lasure (Eds.) More Gene Manipulations in Fungi, (1991) Academic Press pp. 70-76 and pp. 396-428 and articles cited therein; U.S. Pat. No. 5,874,276 and Fungal Genetic Stock Center Catalogue of Strains, (FGSC).

Useful vectors may be obtained from Promega and Invitrogen. Some specific useful vectors include pBR322, pUC18, pUC100, pDONTm201, pENTRTm, pGEN(11)3Z and pGEN4D4Z. However, other forms of expression vectors which serve equivalent functions and which are, or become, known in the art can also be used. Thus, a wide variety of host/expression vector combinations may be employed in expressing the DNA sequences disclosed herein. Useful expression vectors, for example, may consist of segments of chromosomal, non-chromosomal and synthetic DNA sequences such as various known derivatives of 5V40 and known bacterial plasmids, e.g., plasmids from E. coli including col El, pCR1, pBR322, pMb9, pUC 19 and their derivatives, wider host range plasmids, e.g., RP4, phage DNAs e.g., the numerous derivatives of phage k, e.g., NM989, and other DNA phages, e.g., M13 and filamentous single stranded DNA phages, yeast plasmids such as the 2.mu plasmid or derivatives thereof.

### C. Production Hosts

The choice of a production host can be any suitable microorganism such as bacteria, fungi and algae. Typically, the choice will depend upon the gene encoding the glycoside hydrolase of interest such as an alpha-L-fucosidase (such as an alpha-L-1,2 fucosidase).

Examples of suitable production hosts include, but are not limited to, bacterial, fungal, plant cells etc. Preferably, the production host may be selected from E. coli, Streptomyces, Hansenula, Trichoderma (particularly T. reesei), Bacillus (e.g. B. subtilis or B. licheniformis), LactoBacillus, Aspergillus (particularly A. niger), a plant cell and/or spores of Bacillus, Trichoderma, or Aspergillus.

In some embodiments, a recombinant alpha-L-fucosidase (such as an alpha-L-1,2 fucosidase) enzyme may be used in the methods and compositions disclosed herein. In a preferred aspect, there is provided a food or feed additive comprising an alpha-L-fucosidase enzyme which is capable of hydrolyzing L-fucose from an alpha-L-fucose moiety from an intestinal mucin layer.

Many standard transfection methods can be used to produce bacterial and filamentous fungal (e.g. Aspergillus or Trichoderma) cell lines that express large quantities of the desired glycoside hydrolase such as an alpha-L-fucosidase (such as an alpha-L-1,2 fucosidase). However, any of the well-known procedures for introducing foreign nucleotide sequences into host cells may be used. These include the use of calcium phosphate transfection, polybrene, protoplast fusion, electroporation, biolistics, liposomes, microinjection, plasma vectors, viral vectors and any of the other well-known methods for introducing cloned genomic DNA, cDNA, synthetic DNA or other foreign genetic material into a host cell. Also, of use is the Agrobacterium-mediated transfection method described in U.S. Pat. No. 6,255,115. It is only necessary that the particular genetic engineering procedure used be capable of successfully introducing at least one gene into the host cell capable of expressing the gene.

Depending upon the host cell used post-transcriptional and/or post-translational modifications may be made. One non-limiting example of a post-transcriptional and/or post-translational modification is “clipping” or “truncation” of a polypeptide. For example, this may result in taking a glycoside hydrolase as described herein such as an alpha-L-fucosidase (such as an alpha-L-1,2 fucosidase) from an inactive or substantially inactive state to an active state as in the case of a pro-peptide undergoing further post-translational processing to a mature peptide having the enzymatic activity. In another instance, this clipping may result in taking a mature a glycoside hydrolase as described herein such as an alpha-L-fucosidase polypeptide and further removing N or C-terminal amino acids to generate truncated forms of the alpha-L-fucosidase that retain enzymatic activity.

Other examples of post-transcriptional or post-translational modifications include, but are not limited to, myristoylation, glycosylation, truncation, lipidation and tyrosine, serine or threonine phosphorylation. The skilled person will appreciate that the type of post-transcriptional or post-translational modifications that a protein may undergo may depend on the host organism in which the protein is expressed. The alpha-L-fucosidase (such as an alpha-L-1,2 fucosidase) can be expressed both with and/or without a signal sequence thereby facilitating both intracellular expression and/or extracellular expression.

Transformation methods for Aspergillus and Trichoderma are described in, for example, Yelton et al. (1984) Proc. Natl. Acad. Sci. USA 81: 1470-1474; Berka et al., (1991) in Applications of Enzyme Biotechnology, Eds. Kelly and Baldwin, Plenum Press (NY); Cao et al., (2000) Sci. 9:991-1001; Campbell et al., (1989) Curr. Genet. 16:53-56; Leong and Berka, Marcel Dekker Inc., NY (1992) pp. 129-148). Reference is also made to WO96100787 and Bajar et al., (1991) Proc. Natl. Acad. Sci. USA 88:8202″28212 for transformation of Fusarium strains.

After the expression vector is introduced into the cells, the transfected or transformed cells are cultured under conditions favoring expression of genes under control of the promoter sequences. In some instances, the promoter sequence is the cbhl promoter.

Large batches of transformed cells can be cultured as described in Ilmen et al 1997 (“Regulation of cellulase gene expression in the filamentous fungus Trichoderma reesei.” Appl. Envir. Microbiol. 63:1298-1306). The medium used to cultivate the cells may be any conventional medium suitable for growing the host cell and obtaining expression of an alpha-fucosidase polypeptide. Suitable media and media components are available from commercial suppliers or may be prepared according to published recipes (e.g., as described in catalogues of the American Type Culture Collection).

In some embodiments, the preparation of a spent whole fermentation broth of a recombinant microorganism can be achieved using any cultivation method known in the art resulting in the expression of enzyme of interest. Fermentation may, therefore, be understood as comprising shake flask cultivation, small- or large-scale fermentation (including continuous, batch, fed-batch, or solid state fermentations) in laboratory or industrial fermenters performed in a suitable medium and under conditions allowing the enzyme to be expressed or isolated. The term “spent whole fermentation broth” is defined herein as unfractionated contents of fermentation material that includes culture medium, extracellular proteins (e.g., enzymes), and cellular biomass. It is understood that the term “spent whole fermentation broth” also encompasses cellular biomass that has been lysed or permeabilized using methods well known in the art.

Host cells may be cultured under suitable conditions that allow expression of an alpha-fucosidase. Expression of the enzymes may be constitutive such that they are continually produced, or inducible, requiring a stimulus to initiate expression. In the case of inducible expression, protein production can be initiated when required by, for example, addition of an inducer substance to the culture medium, for example dexamethasone or IPTG or sophorose.

Polypeptides can also be produced recombinantly in an in vitro cell-free system, such as the TNT™ (Promega) rabbit reticulocyte system. An expression host also can be cultured in the appropriate medium for the host, under aerobic conditions. Shaking or a combination of agitation and aeration can be provided, with production occurring at the appropriate temperature for that host, e.g., from about 25° C. to about 75° C. (e.g., 30° C. to 45° C.), depending on the needs of the host and production of the desired alpha-fucosidase.

Culturing can occur from about 12 to about 100 hours or greater (and any hour value there between, e.g., from 24 to 72 hours). Typically, the culture broth is at a pH of about 4.0 to about 8.0, again depending on the culture conditions needed for the host relative to production of the enzyme of interest, such as, a fucosidase. Since production hosts and transformed cells can be cultured in conventional nutrient media. The culture media for transformed host cells may be modified as appropriate for activating promoters and selecting transformed cells. The specific culture conditions, such as temperature, pH and the like, may be those that are used for the host cell selected for expression, and will be apparent to those skilled in the art. In addition, preferred culture conditions may be found in the scientific literature such as Sambrook, (1982) supra; Kieser, T, M J. Bibb, M J. Buttner, K F Chater, and D. A. Hopwood (2000) PRACTICAL STREPTOMYCES GENETICS. John Innes Foundation, Norwich UK; Harwood, et al., (1990) MOLECULAR BIOLOGICAL METHODS FOR BACILLUS, John Wiley and/or from the American Type Culture Collection (ATCC).

Any of the fermentation methods well known in the art can suitably be used to ferment the transformed or the derivative fungal strain as described above. A classical batch fermentation is a closed system, where the composition of the medium is set at the beginning of the fermentation, and the composition is not altered during the fermentation. At the beginning of the fermentation, the medium is inoculated with the desired organism(s). In other words, the entire fermentation process takes place without addition of any components to the fermentation system throughout.

Alternatively, a batch fermentation qualifies as a “batch” with respect to the addition of the carbon source. Moreover, attempts are often made to control factors such as pH and oxygen concentration throughout the fermentation process. Typically, the metabolite and biomass compositions of the batch system change constantly up to the time the fermentation is stopped. Within batch cultures, cells progress through a static lag phase to a high growth log phase and finally to a stationary phase, where growth rate is diminished or halted. Left untreated, cells in the stationary phase would eventually die. In general, cells in log phase are responsible for the bulk of production of product. A suitable variation on the standard batch system is the “fed-batch fermentation” system. In this variation of a typical batch system, the substrate is added in increments as the fermentation progresses. Fed-batch systems are useful when it is known that catabolite repression would inhibit the metabolism of the cells, and/or where it is desirable to have limited amounts of substrates in the fermentation medium.

Measurement of the actual substrate concentration in fed-batch systems is difficult and is therefore estimated on the basis of the changes of measurable factors, such as pH, dissolved oxygen and the partial pressure of waste gases, such as CO₂. Batch and fed-batch fermentations are well known in the art.

Continuous fermentation is another known method of fermentation. It is an open system where a defined fermentation medium is added continuously to a bioreactor, and an equal amount of conditioned medium is removed simultaneously for processing. Continuous fermentation generally maintains the cultures at a constant density, where cells are maintained primarily in log phase growth. Continuous fermentation allows for the modulation of one or more factors that affect cell growth and/or product concentration. For example, a limiting nutrient, such as the carbon source or nitrogen source, can be maintained at a fixed rate and all other parameters are allowed to moderate. In other systems, a number of factors affecting growth can be altered continuously while the cell concentration, measured by media turbidity, is kept constant. Continuous systems strive to maintain steady state growth conditions. Thus, cell loss due to medium being drawn off should be balanced against the cell growth rate in the fermentation. Methods of modulating nutrients and growth factors for continuous fermentation processes, as well as techniques for maximizing the rate of product formation, are well known in the art of industrial microbiology.

Separation and concentration techniques are known in the art and conventional methods can be used to prepare a concentrated solution or broth comprising an alpha-fucosidase polypeptide of the invention. After fermentation, a fermentation broth is obtained, the microbial cells and various suspended solids, including residual raw fermentation materials, are removed by conventional separation techniques in order to obtain an enzyme-containing solution. Filtration, centrifugation, microfiltration, rotary vacuum drum filtration, ultrafiltration, centrifugation followed by ultra-filtration, extraction, or chromatography, or the like, are generally used.

It may at times be desirable to concentrate a solution or broth comprising an the polypeptide of interest to optimize recovery. Use of un-concentrated solutions or broth would typically increase incubation time in order to collect the enriched or purified enzyme precipitate. The enzyme-containing solution can be concentrated using conventional concentration techniques until the desired enzyme level is obtained. Concentration of the enzyme containing solution may be achieved by any of the techniques discussed herein. Examples of methods of enrichment and purification include but are not limited to rotary vacuum filtration and/or ultrafiltration.

A glycoside hydrolase as described herein, such as an alpha-L-fucosidase enzyme, can be tested for activity using a variety of tests known in the art. For example, activity can be tested by combining the enzyme with glycoprotein or oligosaccharide and water as necessary. Activity can be measured by analysis of reaction products, which can be separated and visualized, for example, by thin layer chromatography or spectrophotometry. An example of a fucose spectrophotometric assay is the Megazyme K-FUCOSE kit (Cao et at. (2014) J Biol Chem 289(37):25624-38.

### D. Feed and Feed Additive Formulations

A glycoside hydrolase, such as an alpha-L-fucosidase (such as an alpha-L-1,2 fucosidase), either alone or in combination with at least one direct fed microbial alone and/or in combination with least one other enzyme may be encapsulated for use in animal feed or a premix. In addition, a glycoside hydrolase, such as an alpha-L-fucosidase, either alone or in combination with at least one direct fed microbial alone and/or in combination with least one protease, amylase, xylanase, beta-glucosidase, and/or phytase, whether or not encapsulated, may be in the form of a granule.

Animal feeds may include plant material such as corn, wheat, sorghum, soybean, canola, sunflower or mixtures of any of these plant materials or plant protein sources for poultry, pigs, ruminants, aquaculture and pets. The terms “animal feed,” “feedstuff and “fodder” are used interchangeably and can comprise one or more feed materials selected from the group comprising a) cereals, such as small grains (e.g., wheat, barley, rye, oats and combinations thereof) and/or large grains such as maize or sorghum; b) by products from cereals, such as corn gluten meal, Distillers Dried Grains with Solubles (DDGS) (particularly corn based Distillers Dried Grains with Solubles (cDDGS), wheat bran, wheat middlings, wheat shorts, rice bran, rice hulls, oat hulls, palm kernel, and citrus pulp; c) protein obtained from sources such as soya, sunflower, peanut, lupin, peas, fava beans, cotton, canola, fish meal, dried plasma protein, meat and bone meal, potato protein, whey, copra, sesame; d) oils and fats obtained from vegetable and animal sources; and/or e) minerals and vitamins.

When used as, or in the preparation of, a feed, such as functional feed, the enzyme or feed additive composition of the present invention may be used in conjunction with one or more of: a nutritionally acceptable carrier, a nutritionally acceptable diluent, a nutritionally acceptable excipient, a nutritionally acceptable adjuvant, a nutritionally active ingredient. For example, there could be mentioned at least one component selected from the group consisting of a protein, a peptide, sucrose, lactose, sorbitol, glycerol, propylene glycol, sodium chloride, sodium sulfate, sodium acetate, sodium citrate, sodium formate, sodium sorbate, potassium chloride, potassium sulfate, potassium acetate, potassium citrate, potassium formate, potassium acetate, potassium sorbate, magnesium chloride, magnesium sulfate, magnesium acetate, magnesium citrate, magnesium formate, magnesium sorbate, sodium metabisulfite, methyl paraben and propyl paraben.

In a preferred embodiment the enzyme or feed additive composition of the present invention is admixed with a feed component to form a feedstuff. The term “feed component” as used herein means all or part of the feedstuff. Part of the feedstuff may mean one constituent of the feedstuff or more than one constituent of the feedstuff, e.g. 2 or 3 or 4 or more. In one embodiment the term “feed component” encompasses a premix or premix constituents.

Preferably, the feed may be a fodder, or a premix thereof, a compound feed, or a premix thereof. A feed additive composition according to the present invention may be admixed with a compound feed, a compound feed component or to a premix of a compound feed or to a fodder, a fodder component, or a premix of a fodder.

The term “fodder” as used herein means any food which is provided to an animal (rather than the animal having to forage for it themselves). Fodder encompasses plants that have been cut. Furthermore, fodder includes silage, compressed and pelleted feeds, oils and mixed rations, and also sprouted grains and legumes.

Fodder may be obtained from one or more of the plants selected from: corn (maize), alfalfa (Lucerne), barley, birdsfoot trefoil, brassicas, Chau moellier, kale, rapeseed (canola), rutabaga (swede), turnip, clover, alsike clover, red clover, subterranean clover, white clover, fescue, brome, millet, oats, sorghum, soybeans, trees (pollard tree shoots for tree-hay), wheat, and legumes.

The term “compound feed” means a commercial feed in the form of a meal, a pellet, nuts, cake or a crumble. Compound feeds may be blended from various raw materials and additives.

These blends are formulated according to the specific requirements of the target animal.

Compound feeds can be complete feeds that provide all the daily required nutrients, concentrates that provide a part of the ration (protein, energy) or supplements that only provide additional micronutrients, such as minerals and vitamins. The main ingredients used in compound feed are the feed grains, which include corn, wheat, canola meal, rapeseed meal, lupin, soybeans, sorghum, oats, and barley.

Suitably a “premix” as referred to herein may be a composition composed of microingredients such as vitamins, minerals, chemical preservatives, antibiotics, fermentation products, and other essential ingredients. Premixes are usually compositions suitable for blending into commercial rations.

As used herein the term “contacted” refers to the indirect or direct application of a glycoside hydrolase as described herein such as an alpha-L-fucosidase (or composition comprising a glycoside hydrolase as described herein such as an alpha-L-fucosidase) to a product (e.g. the feed). Examples of application methods which may be used, include, but are not limited to, treating the product in a material comprising the feed additive composition, direct application by mixing the feed additive composition with the product, spraying the feed additive composition onto the product surface or dipping the product into a preparation of the feed additive composition. In one embodiment the feed additive composition of the present invention is preferably admixed with the product (e.g. feedstuff). Alternatively, the feed additive composition may be included in the emulsion or raw ingredients of a feedstuff.

It is also possible that alpha-L-fucosidases (or a composition comprising alpha-L-fucosidases) described herein can be homogenized to produce a powder. In an alternative embodiment, a glycoside hydrolase as described herein such as an alpha-L-fucosidase (or composition comprising a glycoside hydrolase as described herein such as an alpha-L-fucosidase) can be formulated to granules as described in (referred to as TPT granules) or WO1997/016076 or WO1992/012645 incorporated herein by reference. “TPT” means Thermo Protection Technology.

In another aspect, when the feed additive composition is formulated into granules the granules comprise a hydrated barrier salt coated over the protein core. The advantage of such salt coating is improved thermo-tolerance, improved storage stability and protection against other feed additives otherwise having adverse effect on the enzyme. Preferably, the salt used for the salt coating has a water activity greater than 0.25 or constant humidity greater than 60% at 20 C. In some embodiments, the salt coating comprises Na2SO4.

A method of preparing a glycoside hydrolase as described herein such as an alpha-L-fucosidase (or composition comprising a glycoside hydrolase as described herein such as an alpha-L-fucosidase) may also comprise the further step of pelleting the powder. The powder may be mixed with other components known in the art. The powder, or mixture comprising the powder, may be forced through a die and the resulting strands are cut into suitable pellets of variable length.

Optionally, the pelleting step may include a steam treatment, or conditioning stage, prior to formation of the pellets. The mixture comprising the powder may be placed in a conditioner, e.g. a mixer with steam injection. The mixture is heated in the conditioner up to a specified temperature, such as from 60-100 C, typical temperatures would be 70 C, 80 C, 85 C, 90 C or 95 C. The residence time can be variable from seconds to minutes and even hours. Such as 5 seconds, 10 seconds, 15 seconds, 30 seconds, 1 minutes 2 minutes, 5 minutes, 10 minutes, 15 minutes, 30 minutes and 1 hour. It will be understood that a glycoside hydrolase as described herein such as an alpha-L-fucosidase (or composition comprising a glycoside hydrolase as described herein such as an alpha-L-fucosidase) described herein are suitable for addition to any appropriate feed material.

It will be understood by the skilled person that different animals require different feedstuffs, and even the same animal may require different feedstuffs, depending upon the purpose for which the animal is reared. Optionally, the feedstuff may also contain additional minerals such as, for example, calcium and/or additional vitamins. In some embodiments, the feedstuff is a corn soybean meal mix.

Feedstuff is typically produced in feed mills in which raw materials are first ground to a suitable particle size and then mixed with appropriate additives. The feedstuff may then be produced as a mash or pellets; the later typically involves a method by which the temperature is raised to a target level and then the feed is passed through a die to produce pellets of a particular size. The pellets are allowed to cool. Subsequently liquid additives such as fat and enzyme may be added. Production of feedstuff may also involve an additional step that includes extrusion or expansion prior to pelleting, in particular by suitable techniques that may include at least the use of steam.

The feedstuff may be a feedstuff for a monogastric animal, such as poultry (for example, broiler, layer, broiler breeders, turkey, duck, geese, water fowl), and swine (all age categories), a ruminant such as cattle (e.g. cows or bulls (including calves)), horses, sheep, a pet (for example dogs, cats) or fish (for example agastric fish, gastric fish, freshwater fish such as salmon, cod, trout and carp, e.g. koi carp, marine fish such as sea bass, and crustaceans such as shrimps, mussels and scallops).

The feed additive composition and/or the feedstuff comprising the same may be used in any suitable form. The feed additive composition may be used in the form of solid or liquid preparations or alternatives thereof Examples of solid preparations include powders, pastes, boluses, capsules, pellets, tablets, dusts, and granules which may be wettable, spray-dried or freeze-dried. Examples of liquid preparations include, but are not limited to, aqueous, organic or aqueous-organic solutions, suspensions and emulsions.

In some applications, the feed additive compositions may be mixed with feed or administered in the drinking water.

A feed additive composition, comprising admixing a fucosidase as taught herein with a feed acceptable carrier, diluent or excipient, and (optionally) packaging.

The feedstuff and/or feed additive composition may be combined with at least one mineral and/or at least one vitamin. The compositions thus derived may be referred to herein as a premix. The feedstuff may comprise at least 0.0001% by weight of the feed additive. Suitably, the feedstuff may comprise at least 0.0005%; at least 0.0010%; at least 0.0020%; at least 0.0025%; at least 0.0050%; at least 0.0100%; at least 0.020%; at least 0.100% at least 0.200%; at least 0.250%; at least 0.500% by weight of the feed additive.

Preferably, a food or feed additive composition may further comprise at least one physiologically acceptable carrier. The physiologically acceptable carrier is preferably selected from at least one of maltodextrin, limestone (calcium carbonate), cyclodextrin, wheat or a wheat component, sucrose, starch, Na2S04, Talc, PVA and mixtures thereof. In a further embodiment, the food or feed additive may further comprise a metal ion chelator. The metal ion chelator may be selected from EDTA or citric acid.

In some embodiments the food or feed additive composition comprises a glycoside hydrolase as described herein such as an alpha-L-fucosidase (such as an alpha-L-1,2 fucosidase) at a level of at least 0.0001 g/kg, 0.001 g/kg, at least 0.01 g/kg, at least 0.1 g/kg, at least 1 g/kg, at least 5 g/kg, at least 7.5 g/kg, at least 10.0 g/kg, at least 15.0 g/kg, at least 20.0 g/kg, at least 25.0 g/kg.

In some embodiments, the food or feed additive comprises the alpha-L-fucosidase (such as an alpha-L-1,2 fucosidase) at a level such that when added to a food or feed material, the feed material comprises the alpha-L-fucosidase in a range of 1-500 mg/kg, 1-100 mg/kg, 2-50 mg/kg or 2-10 mg/kg. In some embodiments of the present invention the food or feed material comprises at least 100, 1000, 2000, 3000, 4000, 5000, 10000, 20000, 30000, 50000, 100000, 500000, 1000000 or 2000000 Units of glycoside hydrolase, such as an alpha-L-fucosidase per kilogram feed or food material. In some embodiments, one unit of a-1,2-fucosidase activity can be defined as the amount of enzyme that can catalyze release of one mole L-fucose per minute from 2′-fucosyllactose under standard assay conditions.

Formulations comprising any glycoside hydrolase as described herein such as alpha-L-fucosidases (such as an alpha-L-1,2 fucosidase) and compositions described herein may be made in any suitable way to ensure that the formulation comprises active enzymes. Such formulations may be as a liquid, a dry powder or a granule. Preferably, the feed additive composition is in a solid form suitable for adding on or to a feed pellet.

Dry powder or granules may be prepared by means known to those skilled in the art, such as, high shear granulation, drum granulation, extrusion, spheronization, fluidized bed agglomeration, fluidized bed spray drying.

A glycoside hydrolase as described herein such as an alpha-L-fucosidases (such as an alpha-L-1,2 fucosidase) and compositions described herein may be coated, for example encapsulated. In one embodiment, the coating protects the enzymes from heat and may be considered a thermoprotectant. In one embodiment the coating protects the enzyme from low pH. Eudragit is one example of a coating material than can be used.

Feed additive composition described herein can be formulated to a dry powder or granules as described in WO2007/044968 (referred to as TPT granules) or WO1997/016076 or WO1992/012645 (each of which is incorporated herein by reference).

In one embodiment animal feed may be formulated to a granule for feed compositions comprising: a core; an active agent; and at least one coating, the active agent of the granule retaining at least 50% activity, at least 60% activity, at least 70% activity, at least 80% activity after conditions selected from one or more of a) a feed pelleting process, b) a steam-heated feed pretreatment process, c) storage, d) storage as an ingredient in an unpelleted mixture, and e) storage as an ingredient in a feed base mix or a feed premix comprising at least one compound selected from trace minerals, organic acids, reducing sugars, vitamins, choline chloride, and compounds which result in an acidic or a basic feed base mix or feed premix.

With regard to the granule at least one coating may comprise a moisture hydrating material that constitutes at least 55% w/w of the granule; and/or at least one coating may comprise two coatings. The two coatings may be a moisture hydrating coating and a moisture barrier coating. In some embodiments, the moisture hydrating coating may be between 25% and 60% w/w of the granule and the moisture barrier coating may be between 2% and 15% w/w of the granule. The moisture hydrating coating may be selected from inorganic salts, sucrose, starch, and maltodextrin and the moisture barrier coating may be selected from polymers, gums, whey and starch.

The feed additive composition may be formulated to a granule for animal feed comprising: a core; an active agent, the active agent of the granule retaining at least 80% activity after storage and after a steam-heated pelleting process where the granule is an ingredient; a moisture barrier coating; and a moisture hydrating coating that is at least 25% w/w of the granule, the granule having a water activity of less than 0.5 prior to the steam-heated pelleting process.

The granule may have a moisture barrier coating selected from polymers and gums and the moisture hydrating material may be an inorganic salt. The moisture hydrating coating may be between 25% and 45% w/w of the granule and the moisture barrier coating may be between 2% and 10% w/w of the granule.

A granule may be produced using a steam-heated pelleting process which may be conducted between 85 C and 95 C for up to several minutes.

Alternatively, the composition is in a liquid formulation suitable for consumption preferably such liquid consumption contains one or more of the following: a buffer, salt, sorbitol and/or glycerol.

Also, the feed additive composition may be formulated by applying, e.g. spraying, the enzyme(s) onto a carrier substrate, such as ground wheat for example. In one embodiment the feed additive composition may be formulated as a premix. By way of example only the premix may comprise one or more feed components, such as one or more minerals and/or one or more vitamins.

In one embodiment at least one DFM and/or glycoside hydrolase such as an alpha-L-fucosidase (whether or not encapsulated) and/or at least one protease, amylase, xylanase, beta-glucosidase, and/or phytase, are formulated with at least one physiologically acceptable carrier selected from at least one of maltodextrin, limestone (calcium carbonate), cyclodextrin, wheat or a wheat component, sucrose, starch, Na2SO4, Talc, PVA, sorbitol, benzoate, sorbate, glycerol, sucrose, propylene glycol, 1,3-propane diol, glucose, parabens, sodium chloride, citrate, acetate, phosphate, calcium, metabisulfite, formate and mixtures thereof.

In some embodiments, a glycoside hydrolase, such as an alpha-L-fucosidase (such as an alpha-L-1,2 fucosidase), will be in a physiologically acceptable carrier. Suitable carriers may be large, slowly metabolised macromolecules such as proteins, polypeptides, liposomes, polysaccharides, polylactic acids, polyglycolic acids, polymeric amino acids, amino acid copolymers and inactive virus particles.

Pharmaceutically acceptable salts can be used, for example mineral acid salts, such as hydrochlorides, hydrobromides, phosphates and sulphates, or salts of organic acids, such as acetates, propionates, malonates and benzoates. Pharmaceutically acceptable carriers in therapeutic compositions may additionally contain liquids such as water, saline, glycerol and ethanol. Additionally, auxiliary substances, such as wetting or emulsifying agents or pH buffering substances, may be present in such compositions. Such carriers enable the pharmaceutical compositions to be formulated as tablets, pills, dragees, capsules, liquids, gels, syrups, slurries and suspensions, for ingestion by the patient. Once formulated, the compositions of the invention can be administered directly to the subject. The subjects to be treated can be animals. However, in one or more embodiments the compositions are adapted for administration to human subjects.

### III. Methods

### A. Methods for Improving Gut Health

The present disclosure relates to a method for improving gut health in an animal comprising administering to the animal an effective amount of a glycoside hydrolase capable of removing at least one alpha-1,2-L-fucose moiety from an intestinal mucin layer. In some embodiments, the glycoside hydrolase is an alpha-L-fucosidase (such as an alpha-L-1,2 fucosidase), for example an alpha-L-fucosidase from glycoside hydrolase family 95 (GH95) or glycoside hydrolase family 29 (GH 29). In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

### 1. Commensal Intestinal Bacteria Populations

In one embodiment, improving gut health comprises promoting the growth of one or more commensal intestinal bacteria. Non-limiting examples of intestinal bacteria whose growth can be promoted following glycoside hydrolase administration include Prevotella spp., Megasphaera spp., Clostridium spp., Blautia spp., Ruminococcus spp., Desulfovibrio spp and/or Barnesiella spp.

Prevotella is a genus of Gram-negative bacteria with species commonly found in the oral, vaginal, and gut microbiota. Non-limiting examples of Prevotella spp. include Prevotella albensis, Prevotella amnii, Prevotella bergensis, Prevotella bivia, Prevotella brevis, Prevotella bryantii, Prevotella buccae, Prevotella buccalis, Prevotella copri, Prevotella dentalis, Prevotella denticola, Prevotella disiens, Prevotella histicola, Prevotella intermedia, Prevotella maculosa, Prevotella marshii, Prevotella melaninogenica, Prevotella micans, Prevotella multiformis, Prevotella nigrescens, Prevotella oralis, Prevotella oris, Prevotella oulorum, Prevotella pallens, Prevotella salivae, Prevotella stercorea, Prevotella timonensis, and/or Prevotella veroralis.

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in one or more Prevotella spp. (such as P. copri) in the intestinal microbiota compared to the amount of Prevotella spp. present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

Megasphaera is a genus of Firmicutes bacteria classified within the class Negativicutes. Non-limiting examples of Megasphaera spp. include Megasphaera hominis, Megasphaera cerevisiae, Megasphaera elsdenii, Megasphaera micronuciformis, Megasphaera paucivorans, and/or Megasphaera sueciensis.

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in one or more Megasphaera spp. (such as M. elsdenii) in the intestinal microbiota compared to the amount of Megasphaera spp. present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

Clostridium is a genus of Gram-positive bacteria that contains around 250 species that include common free-living bacteria, as well as important pathogens. This genus is a diverse grouping and several species are indigenous to the healthy gastrointestinal microbiome of mammals. Non-limiting examples of Clostridium spp. are those of Clostridium clusters IV and XIVa (the Clostridium coccoides and Clostridium leptum groups, respectively; see Guo et al., 2020, Journal of Animal Science and Biotechnology, 11:24, incorporated by reference herein).

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in one or more Clostridium spp. in the intestinal microbiota compared to the amount of Clostridium spp. present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

Blautia is a genus of anaerobic bacteria with probiotic characteristics that occur widely in the feces and intestines of mammals (see Liu et al., 2021, Gut Microbes. 3(1): 1875796, incorporated by reference herein). Non-limiting examples of Blautia spp. include Blautia coccoides, Blautia hansenii, Blautia hydrogenotrophica, Blautia luti, Blautia producta, Blautia schinkii, Blautia wexlerae, Blautia glucerasea, Blautia stercoris, Blautia faecis, Blautia obeum, Blautia caecimuris, Blautia massiliensis, Blautia phocaeensis, Blautia marasmi, Blautia provencensis, Blautia hominis, Blautia argi, Blautia brookingsii, and/or Blautia faecicola.

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in one or more Blautia spp. in the intestinal microbiota compared to the amount of Blautia spp. present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

Ruminococcus is a genus of bacteria in the class Clostridia. They are anaerobic, Gram-positive gut microbes found in significant numbers in the human gut microbiota. Non-limiting examples of Ruminococcus spp. include Ruminococcus albus, Ruminococcus bromii, Ruminococcus callidus, Ruminococcus flavefaciens, Ruminococcus gauvreauii, Ruminococcus gnavus, Ruminococcus lactaris, Ruminococcus obeum, and/or Ruminococcus torques.

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in one or more Ruminococcus spp. in the intestinal microbiota compared to the amount of Ruminococcus spp. present in the intestinal microbiota of an animal that has not been administered an effective amount of a glycoside hydrolase capable of removing at least one alpha-1,2-L-fucose moiety from an intestinal mucin layer.

Barnesiella is a genus from the family of Barnesiellaceae which are Gram-negative, anaerobic and non-spore-forming bacteria. Non-limiting examples of Barnesiella spp. include Barnesiella viscericola and Barnesiella intestinihominis.

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in one or more Barnesiella spp. in the intestinal microbiota compared to the amount of Barnesiella spp. present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

Desulfovibrio is a genus of Gram-negative sulfate-reducing bacteria. Desulfovibrio species are commonly found in aquatic environments with high levels of organic material, as well as in water-logged soils, and form major community members of extreme oligotrophic habitats such as deep granitic fractured rock aquifers. Like other sulfate-reducing bacteria, Desulfovibrio were long considered to be obligately anaerobic. This is not strictly correct: while growth may be limited, these bacteria can survive in O₂-rich environments. These types of bacteria are known as aerotolerant. Non-limiting examples of Desulfovibrio spp. include D. acrylicus, D. aerotolerans, D. aespoeensis, D. africanus, D. alaskensis, D. alcoholivorans, D. alkalitolerans, D. aminophilus, D. arcticus, D. baarsii, D. baculatus, D. bastinii, D. biadhensis, D. bizertensis, D. burkinensis, D. butyratiphilus, D. capillatus, D. carbinolicus, D. carbinoliphilus, D. cuneatus, D. dechloracetivorans, D. desulfuricans, D. ferrireducens, D. frigidus, D. fructosivorans, D. furfuralis, D. gabonensis, D. giganteus, D. gigas, D. gracilis, D. halophilus, D. hydrothermalis, D. idahonensis, D. indonesiensis, D. inopinatus, D. intestinalis, D. legallii, D. alitoralis, D. longreachensis, D. longus, D. magneticus, D. marinus, D. marinisediminis, D. marrakechensis, D. mexicanus, D. multispirans, D. oceani, D. oxamicus, D. oxyclinae, D. paquesii, D. piezophilus, D. pigra, D. portus, D. profundus, D. psychrotolerans, D. putealis, D. salixigens, D. sapovorans, D. senezii, D. simplex, D. sulfodismutans, D. termitidis, D. thermophilus, D. tunisiensis, D. vietnamensis, D. vulgaris, and D. zosterae.

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in one or more Desulfovibrio spp. in the intestinal microbiota compared to the amount of Desulfovibrio spp. present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet.

Increases in the growth or quantity of one or more commensal intestinal bacteria can be detected by standard methods, including direct or indirect sampling of intestinal microbiota followed by 16s rRNA sequencing, whole genomic sequencing, or in accordance with the methods described in the Examples herein.

### 2. Methanogenic Intestinal Populations

In another embodiment, improving gut health comprises decreasing growth of one or more methanogenic archaea in the gut. Non-limiting examples of methanogenic archaea whose growth can be decreased following glycoside hydrolase administration include Methanobrevibacter spp. and Methanomassiliicoccus spp. (e.g. Methanomassiliicoccus luminyensis).

Methanobrevibacter is a genus of the family Methanobacteriaceae. The species within Methanobrevibacter are strictly anaerobic archaea that produce methane, for the most part through the reduction of carbon dioxide via hydrogen. Most species live in the intestines of larger organisms, such as termites and are responsible for the large quantities of greenhouse gases that they produce. Non-limiting examples of Methanobrevibacter spp. include M. acididurans, M. arboriphilus, M. curvatus, M. cuticularis, M. filiformis, M. gottschalkii, M. millerae, M. olleyae, M. oralis, M. ruminantium, M. smithii, M. thaueri, M. woesei, and/or M. wolinii.

In some embodiments, administering an effective amount of a glycoside hydrolase (e.g., an alpha-L-fucosidase) capable of removing at least one alpha-1,2-L-fucose moiety from an intestinal mucin layer to an animal results in a decrease (such as a decrease by any of about 5%, 10%, 15%, 20%, 25%, 30%, 35%, 40%, 45%, 50%, 55%, 60%, 65%, 70%, 80%, 85%, 90%, 95%, or 100%, inclusive of all values in between these percentages) in one or more Methanobrevibacter spp. (such as M. smithii) in the intestinal microbiota compared to the amount of Methanobrevibacter spp. present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In other embodiments, administering an effective amount of a glycoside hydrolase (e.g., an alpha-L-fucosidase) capable of removing at least one alpha-1,2-L-fucose moiety from an intestinal mucin layer to an animal results in a decrease (such as a decrease by any of about 5%, 10%, 15%, 20%, 25%, 30%, 35%, 40%, 45%, 50%, 55%, 60%, 65%, 70%, 80%, 85%, 90%, 95%, or 100%, inclusive of all values in between these percentages) in one or more Methanomassiliicoccus spp. (e.g. Methanomassiliicoccus luminyensis) in the intestinal microbiota compared to the amount of Methanomassiliicoccus spp. present in the intestinal microbiota of an animal that has not been administered an effective amount of a glycoside hydrolase capable of removing at least one alpha-1,2-L-fucose moiety from an intestinal mucin layer.

In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet.

Reductions in the growth or quantity of one or more methanogenic archaea in the gut can be detected by standard methods, including direct or indirect sampling of intestinal microbiota followed by 16s rRNA sequencing, whole genomic sequencing, or in accordance with the methods described in the Examples herein.

### 3. Secretory IgA

In an additional embodiment, improving gut health comprises increasing Secretory IgA (SIgA) levels in the gut, for example by increasing the quantity of intestinal IgA including, without limitation, intestinal IgA bound to fecal microbes. SIgA is the main antibody class secreted at all mucosal surfaces where it augments the barrier function through specific interaction with pathogenic and commensal microbes, microbial metabolites, and ingested macromolecules. In addition to excluding potentially harmful interactions with host tissues, SIgA can affect the composition and metabolic activity of microbes living within the mucosa helping to actively select for beneficial microbial communities. Increased levels of SIga (including SIgA attached to the surface of fecal microbes) are positively correlated states of good health and has been used as a marker to assess mucosal immune function in human and animal studies.

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200%, 250%, 300%, 350%, 400%, 450%, 500%, 550%, 600%, 650%, 700%, 750%, 800%, 850%, 900%, 950%, 1000%, 1100%, 1200%, 1300%, 1400%, 1500%, 1600%, 1700%, 1800%, 1900%, 2000%, 2100%, 2200%, 2300%, 2400%, 2500% or more, inclusive of all values in between these percentages) in SIgA levels in the gut (such as an increased quantity of SIgA bound to fecal microbes) compared to the amount of SIgA levels present in the gut of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet.

Detection of SIgA levels in the gut, including detection of SIgA bound to fecal microbes can be performed by standard techniques in accordance with the methods described in the Examples herein.

### 4. Neutrophils

In an additional embodiment, improving gut health comprises decreasing the quantity of neutrophil levels in the gut. Neutrophils are a type of white blood cell that help heal damaged tissues and resolve infections. Neutrophil blood levels increase naturally in response to infections, injuries, and other types of stress. Inflammation is associated with increased levels of neutrophils so lower levels would indicate that there is less inflammation.

In some embodiments, administering an effective amount of a glycoside hydrolase (e.g., an alpha-L-fucosidase) capable of removing at least one alpha-1,2-L-fucose moiety from an intestinal mucin layer to an animal results in a decrease (such as a decrease by any of about 5%, 10%, 15%, 20%, 25%, 30%, 35%, 40%, 45%, 50%, 55%, 60%, 65%, 70%, 80%, 85%, 90%, 95%, or 100%, inclusive of all values in between these percentages) in neutrophils in the gut of the animal compared to the amount of neutrophils present in the intestinal microbiota of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet.

Detection of neutrophil levels in the gut can be performed by standard techniques in accordance with the methods described in the Examples herein.

### 5. Feed Intake and FCR

In another embodiment, improving gut health comprises increasing the feed intake of the animal. Feed intake in certain livestock species has been linked to certain taxa in the microbiome. For example, in a study with commercial Duroc pigs, it was revealed that animals that harbored a Prevotella-predominant enterotype had significantly higher average daily feed intake (ADFI). Further, it was shown that Prevotella was a hub bacterium in the co-abundance network that exhibited strong positive association with ADFI (Yang et al., 2018, BMC Microbiol. 2018, 18, 215).

In some embodiments, administering an effective amount of a glycoside hydrolase (e.g., an alpha-L-fucosidase) capable of removing at least one alpha-1,2-L-fucose moiety from an intestinal mucin layer to an animal results in an increase (such as an increase by any of about 5%, 10%, 15%, 20%, 25%, 30%, 35%, 40%, 45%, 50%, 55%, 60%, 65%, 70%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, 200% or more, inclusive of all values in between these percentages) in ADFI compared to the ADFI of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet.

In some embodiments, administering an effective amount of a glycoside hydrolase (e.g., an alpha-L-fucosidase) capable of removing at least one alpha-1,2-L-fucose moiety from an intestinal mucin layer to an animal results in a decrease (such as an decrease by any of about 5%, 10%, 15%, 20%, 25%, 30%, 35%, 40%, 45%, 50%, 55%, 60%, 65%, 70%, 80%, 85%, 90%, 95%, or 100%, inclusive of all values in between these percentages) in feed conversion ratio (FCR) compared to the FCR of an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

### 6. Mortality

In another embodiment, improving gut health comprises decreasing mortality of animals (for example, newly weaned animals, such as piglets). Maturation of adaptive immunity in animals (such as piglets) relies on cues received from microbes that colonize the gut through the weaning process. Abrupt weaning, which is common in large scale livestock production, can result in disruptions in immune development due to inflammation or establishment of microbial communities that do not support proper immune development. This can lead to excess mortality in newly-weaned animals.

In some embodiments, administering an effective amount of a glycoside hydrolase (e.g., an alpha-L-fucosidase) capable of removing at least one alpha-1,2-L-fucose moiety from an intestinal mucin layer to an animal results in a decrease (such as a decrease by any of about 1%, 2%, 3%, 4%, 5%, 6%, 7%, 8%, 9%, 10%, 11%, 12%, 13%, 14%, 15%, 16%, 17%, 18%, 19%, 20%, 25%, 30%, 35%, 40%, 45%, 50%, 55%, 60%, 65%, 70%, 80%, 85%, 90%, 95%, or 100%, inclusive of all values in between these percentages) in mortality in animals (such as newly-weaned animals) compared to the amount of mortality in animals (such as newly-weaned animals) that have not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet.

### B. Methods for Decreasing Methane Emissions

Methane is a significant greenhouse gas. One ton of methane is equivalent to approximately 21 to 22 tons of carbon dioxide with respect to its global warming potential. As a result, the reduction of one ton of methane emissions can be considered as achieving a reduction of 21 or more tons of carbon dioxide and can generate about 21 tons of carbon credits (as carbon dioxide) in the evolving Greenhouse Gas (GHG) market. Moreover, methane has about a 12 year half-life in the atmosphere and is increasing worldwide at an annual rate of around one half of one percent (0.5%) per year. Accordingly, reduction of presently excessive methane emissions into the atmosphere is desirable.

The emission of greenhouse gases (GHG) including methane from livestock is believed to be a significant contributor to global warming. Some scientists estimate that livestock contributes up to thirty-seven percent (37%) of the total global methane (CH₄) budget.

Provided herein are methods for decreasing methane emissions in an animal comprising administering to the animal an effective amount of a glycoside hydrolase capable of removing at least one alpha-1,2-L-fucose moiety from an intestinal mucin layer. Without being bound to theory, it is believed that decreased growth of one or more methanogenic archaea species (such as a Methanobrevibacter spp., for example M. smithii) in the intestinal tract of the animal following administration of the glycoside hydrolase results in decreased methane emissions from the animal.

In some embodiments, administering an effective amount of a glycoside hydrolase (e.g., an alpha-L-fucosidase) capable of removing at least one alpha-1,2-L-fucose moiety from an intestinal mucin layer to an animal results in a decrease (such as a decrease by any of about 5%, 10%, 15%, 20%, 25%, 30%, 35%, 40%, 45%, 50%, 55%, 60%, 65%, 70%, 80%, 85%, 90%, 95%, or 100%, inclusive of all values in between these percentages) in methane emissions from the gut of the animal compared to the methane emissions from an animal that has not been administered an effective amount of a glycoside hydrolase capable of removing at least one alpha-1,2-L-fucose moiety from an intestinal mucin layer. In some embodiments, the glycoside hydrolase comprises a polypeptide at least about 60% identical (such as about 60%, 65%, 70%, 75%, 80%, 85%, 90%, 91%, 92%, 93%, 94%, 95%, 96%, 97%, 98%, 99%, or 100% identical, inclusive of values in between these percentages) to the glycoside hydrolase encoded by SEQ ID NO:3.

In some embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 days or more. In other embodiments, the glycoside hydrolase (e.g., an alpha-L-fucosidase) capable of removing at least one alpha-1,2-L-fucose moiety from an intestinal mucin layer is administered to the animal for at least 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 weeks or more. In some embodiments, the animal is a newly-weaned animal, such as a piglet.

C. Co-Administration with DFMs or Other Enzymes

The method disclosed herein further comprises administering to the animal an effective amount of a glycoside hydrolase such as an alpha-L-fucosidase (such as an alpha-L-1,2 fucosidase) in combination with at least one direct fed microbial alone or in combination with least one other enzyme.

Furthermore, a glycoside hydrolase as described herein such as an alpha-L-fucosidase (such as an alpha-L-1,2 fucosidase), either alone or in combination with at least one direct fed microbial alone and/or in combination with least one other enzyme may be encapsulated for use in animal feed or a premix. In addition, a glycoside hydrolase as described herein such as an alpha-L-fucosidase, either alone or in combination with at least one direct fed microbial alone and/or in combination with least one other enzyme, whether or not encapsulated, may be in the form of a granule.

It is believed that a glycoside hydrolase as described herein such as an alpha-L-fucosidase enzyme (such as an alpha-L-1,2 fucosidase) as described herein may be used in combination with one or more additional enzymes. In some embodiments, the one or more additional enzymes is selected from the group consisting of those involved in protein degradation including carboxypeptidases preferably carboxypeptidase A, carboxypeptidase Y, A. niger aspartic acid proteases of PEPAa, PEPAb, PEPAc and PEPAd, elastase, amino peptidases, pepsin or pepsin-like, trypsin or trypsin-like proteases, acid fungal proteases and bacterial proteases including subtilisin and its variants, and of those involved in starch metabolism, fibre degradation, lipid metabolism, proteins or enzymes involved in glycogen metabolism, enzymes which degrade other contaminants, acetyl esterases, amylases, arabinases, arabinofuranosidases, exo- and endo-peptidases, catalases, cellulases, chitinases, chymosin, cutinase, deoxyribonucleases, epimerases, esterases, formamidase, galactosidases, exo-glucanases, glucan lyases, endo-glucanases, glucoamylases, glucose oxidases, glucosidases, for example a or 13-glucosidases, glucuronidases, hemicellulases, hydrolases, invertases, isomerases, laccases, phenol oxidases, lipase, lyases, mannosidases, oxidases, oxidoreductases, pectinase, pectate lyases, pectin acetyl esterases, pectin depolymerases, peptidase, pectin methyl esterases, pectinolytic enzymes, peroxidases, phenoloxidases, phytase, polygalacturonases, rhamno-galacturonases, ribonucleases, thaumatin, transferases, transport proteins, transglutaminases, xylanases, hexose oxidase (D-hexose: (3/4-oxidoreductase, EC 1.1.3.5), acid phosphatases and/or others or combinations thereof. These include enzymes that, for example, modulate the viscosity of the composition or feed.

Furthermore, a glycoside hydrolase as described herein such as an alpha-L-fucosidase (such as an alpha-L-1,2 fucosidase) may be encapsulated so as to withstand the acid pH found in the stomach. The glycoside hydrolase as described herein such as an alpha-L-fucosidase, whether or not encapsulated, may be used alone or in combination with at least one direct fed microbial and may be administered in an animal feed or premix. Furthermore, the glycoside hydrolase as described herein such as an alpha-L-fucosidase, whether or not encapsulated, may be used alone or in combination with at least one direct fed microbial and may be administered in an animal feed or premix and the alpha-L-fucosidase may be in the form of a granule or liquid. The preferred form is a granule.

The invention can be further understood by reference to the following examples, which are provided by way of illustration and are not meant to be limiting.

### EXAMPLES

### Example 1: Influence of Dietary Supplementation of Fucosidase on ETEC-Infected Pigs

This Example 1) investigated the influence of dietary supplementation of fucosidase enzyme (FE) on diarrhea score, growth performance, fecal shedding, and complete blood count in weanling pigs experimentally infected with an enterotoxigenic E. coli (ETEC); and 2) generated samples for future determination of dietary FE effects on ETEC attachment in the intestine, gut barrier function and integrity, systemic immunity, and gut microbiome of weanling pigs infected with ETEC.

### Materials and Methods

A total of 60 weanling piglets (around 21 d old) with an equal number of barrows and gilts were used in this experiment. All piglets were subjected to genotyping for F18 receptor status through RFLP and PCR tests to ensure all piglets enrolled are susceptible to F18 ETEC infection. Blood genotyping of sows and boars were analyzed in an external laboratory and only piglets sensitive to ETEC (blood group H, same as blood group O, determined by FUT genotyping) were used for the study.

Piglets were weaned and housed individually in pens for 21 days, including 7 days before (pre-inoculation) and 14 days after the first ETEC challenge (post-inoculation). There were 15 replicates per treatment for a total of 60 pigs in the experiment. The experiment was a randomized complete block design with body weight within sex and litter as the blocks and the pig as the experimental unit. After 7-day adaptation, all piglets were orally inoculated with 3 mL F18 ETEC/day for 3 consecutive days from d 0 to d 2 post-inoculation. The F18 ETEC was originally isolated from a field disease outbreak by the University of Illinois, Veterinary Diagnostic Lab. The F18 ETEC expresses heat-labile toxin, heat-stable toxin b, and Shiga-like toxins and was provided at 10¹⁰ cfu per 3-mL dose in PBS.

The piglets had ad libitum access to feed and water. Environmental enrichment was provided for each pig. The light was on at 0700 and off at 1900 h daily in the environmental control unit. The room temperature was 25 to 27° C. throughout the experiment. The experimental diets were offered to the piglets throughout the 21-day study. The 4 experimental diets whereas below:
1) Control diet based on corn and soybean meal
2) Control diet supplemented with 50 mg FE/kg of feed
3) Control diet supplemented with 100 mg FE/kg of feed
4) Control diet supplemented with 200 mg FE/kg of feed

Diets were formulated to meet pig nutritional requirements (NRC, 2012). Spray-dried plasma and high levels of zinc oxide exceeding nutritional requirements were not included in the diets. Diets also excluded the use of antibiotics and phytase. All diets were provided as meal form.

On d 14 post-inoculation, all pigs were euthanized. Before euthanization, pigs were anesthetized with 1 mL mixture of 100 mg telazol, 50 mg ketamine, and 50 mg xylazine (2:1:1) by intramuscular injection. After anesthesia, intracardiac injection with 78 mg sodium pentobarbital per 1 kg of BW was used to euthanize pigs.

### Response Criteria and Sampling:

Growth performance: During the experiment, scores for diarrhea and alertness were assigned twice daily from d 0 pre-inoculation to d 14 post-inoculation. The diarrhea score was assessed visually by 2 independent evaluators, using a 5-scale system (1=normal feces, 2=moist feces, 3=mild diarrhea, 4=severe diarrhea, and 5=watery diarrhea). The frequency of diarrhea was calculated as the percentage of the pen days with a diarrhea score of 3 or greater. The alertness score was assessed using a 3-scale system (1=normal, 2=slightly depressed or listless, and 3=severely depressed or recumbent). Pigs were weighed on weaning day (d −7), d 0, 7, and 14 post-inoculation. Feed intake was recorded throughout the experiment. The average daily gain, average daily feed intake, and Gain: Feed were calculated for each interval from d −7 to 0, d 0 to 7 PI, d 7 to 14 post-inoculation, as well as cumulative from d −7 to 14 PI and d 0 to 14 post-inoculation.

ETEC fecal shedding: Fecal samples were collected from the rectum using a fecal loop or cotton swap on d 0 before E. coli inoculation, d 2, 5, 7, 10, and 14 post-inoculation to test for β-hemolytic coliforms and percentage (Song et al., 2012; Liu et al., 2013).

Complete blood count analysis: Blood samples were collected from the jugular vein of all pigs with EDTA to yield whole blood at the beginning of the experiment, d 0 (pre-inoculation), and d 2, 5, and 14 post-inoculation. Whole blood samples were used to measure total and differential blood cell counts using a multiparameter, automated programmed hematology analyzer (Drew/ERBA Scientific 950 FS Hematological Analyzer, Drew Scientific Inc., Miami, FL)

Fecal samples: were also collected from the rectum at the beginning of the experiment, on d 0 (pre-inoculation), d 5 and 14 post-inoculation and stored in −80° C. freezer for gut microbiome analysis.

Blood samples: were collected from the jugular vein of all pigs without EDTA to yield plasma at the beginning of the experiment, d 0 (pre-inoculation), and d 2, 5, and 14 post-inoculation. Serum samples were analyzed for a pro-inflammatory cytokine (TNF-α, IL-10), cortisol, and acute phase proteins (C-reactive protein and haptoglobin) using commercial ELISA kits.

### Statistical Analysis

Normality of data was verified, and outliers were identified using the UNIVARIATE procedure (SAS Inst. Inc., Cary, NC). Outliers were identified and removed as values that deviated from the treatment mean by more than 3 times the interquartile range. Data were analyzed by ANOVA using the PROC MIXED of SAS (SAS Institute Inc., Cary, NC) in a randomized complete block design with the pig as the experimental unit. The statistical model included diet as the main effect and block as random effect. Treatment means were separated by using the LSMEANS statement and the PDIFF option of PROC MIXED. Contrast statements were applied to analyze the dose effects (linear and quadratic) of FE. The Chi-squared test was used to analyze the frequency of diarrhea. Statistical significance and trend were considered at P<0.05 and 0.05≤P<0.10, respectively.

### Results

Growth performance data from the study, as shown in Table 1, showed both linear and quadratic increase (P<0.05) in daily feed intake for d 0 to 7, d 7 to 14 and d 7 to 14 post-inoculation, with increasing dose of FE. However, body weight for d 7 and d 14 post-inoculation only showed a numerical improvement with enzyme supplementation.

TABLE 1
Body weight, ADG, ADFI, diarrhea, and fecal shedding scores from study

| | Dietary treatments | | | | | P-value | | |
|---|---|---|---|---|---|---|---|---|
| | FC0 | FC50 | FC100 | FC200 | SEM | Model | Linear | Quadratic |
| Body Weight, Kg | | | | | | | | |
| Pld −7 | 7.00 | 6.98 | 7.33 | 6.73 | 0.224 | 0.269 | | |
| Pld 0 | 7.99 | 8.14 | 8.30 | 7.68 | 0.288 | 0.430 | | |
| Pld 7 | 9.95 | 10.23 | 10.39 | 10.03 | 0.409 | 0.812 | | |
| Pld 14 | 13.75 | 14.27 | 14.65 | 14.03 | 0.590 | 0.630 | | |
| ADG, g/d | | | | | | | | |
| Pld −7 to 0 | 140.8 | 166.4 | 138.7 | 135.0 | 19.85 | 0.579 | | |
| Pld 0 to 7 | 280.1 | 298.6 | 298.8 | 336.0 | 27.47 | 0.480 | 0.122 | 0.298 |
| Pld 7 to 14 | 542.9 | 577.1 | 609.2 | 571.7 | 38.84 | 0.566 | 0.333 | 0.591 |
| Pld 0 to 14 | 411.5 | 437.9 | 454.0 | 453.8 | 27.97 | 0.553 | 0.304 | 0.511 |
| ADFI, g/d | | | | | | | | |
| Pld −7 to 0 | 299.3 | 282.9 | 287.2 | 280.0 | 18.96 | 0.842 | 0.740 | 0.511 |
| Pld 0 to 7 | 464.0^{b} | 494.3^{ab} | 545.2^{a} | 555.5^{a} | 32.45 | 0.096 | 0.013 | 0.011 |
| Pld 7 to 14 | 740.7^{b} | 840.7^{ab} | 917.0^{a} | 865.2^{ab} | 58.03 | 0.095 | 0.007 | 0.017 |
| Pld 0 to 14 | 602.4^{b} | 667.5^{ab} | 731.1^{a} | 710.4^{ab} | 42.02 | 0.073 | 0.002 | 0.004 |
| Diarrhea | | | | | | | | |
| Diarrhea days | 13.1^{ab} | 12.4^{b} | 13.8^{a} | 13.3^{ab} | 0.47 | 0.201 | 0.452 | 0.732 |
| Frequency, % | 90.0^{ab} | 82.6^{b} | 91.8^{a} | 88.8^{ab} | 3.07 | 0.156 | 0.858 | 0.939 |
| ETEC Fecal shedding, %* | | | | | | | | |
| Pld 0 | 0.0 | 0.0 | 0.0 | 0.0 | | | | |
| Pld 2 | 90.0 | 92.1 | 90.9 | 86.5 | | | | |
| Pld 5 | 86.4 | 80.2 | 77.6 | 69.9 | | | | |
| Pld 7 | 41.4 | 35.6 | 40.4 | 31.3 | | | | |
| Pld 10 | 16.5^{a} | 0.0^{b} | 1.2^{b} | 15.2^{a} | | | | |
| Pld 14 | 5.8^{a} | 0.0^{b} | 0.0^{b} | 0.0^{b} | | | | |

^{ab}LS Means with different superscript differ (Student's t-test, P < 0.05)
*Time by Treatment interaction, P < 0.05

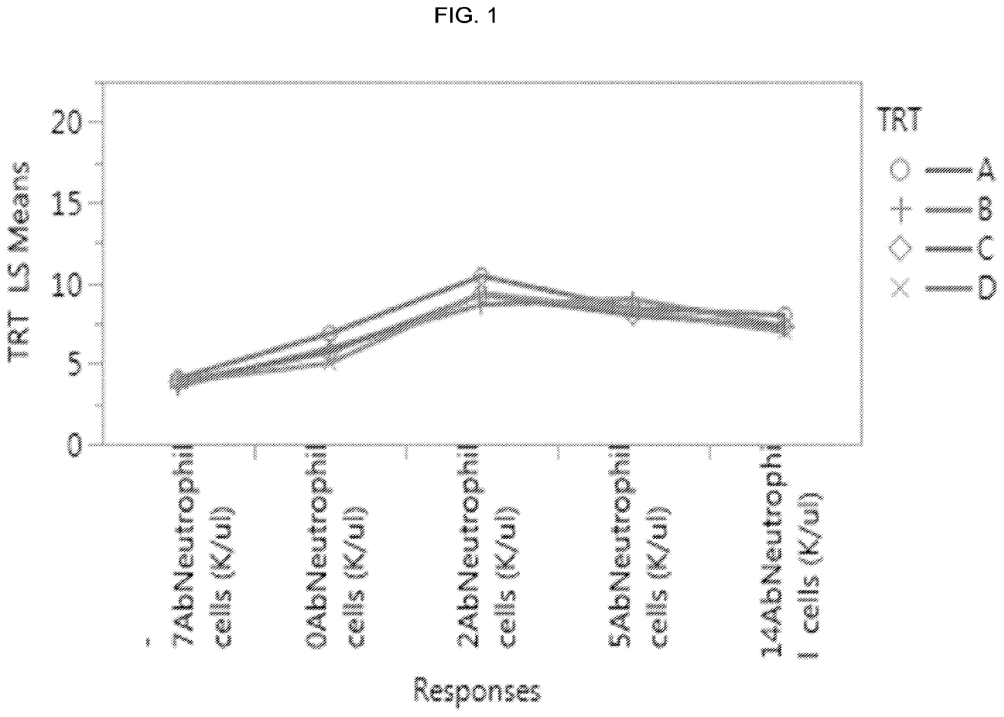

Similarly, body weight gain during the post-inoculation period also showed a numerical improvement with enzyme addition. Piglets fed diets supplemented with 50 mg FE showed a significant reduction in frequency of diarrhea when compared to control. Significant reduction in fecal shedding of ETEC was observed on d 10 and 14, post-inoculation with increasing dose of FE, except for 200 mg FE dosage on d 10 which showed no difference (P>0.05) when compared to control. For complete blood count, d0 neutrophil counts showed a significant (P<0.05) treatment effect where FE supplementation showed a linear reduction in neutrophil levels, see FIG. 1 and Table 2 below.

TABLE 2

| Treatment | d −7 | d 0 | d 2 | d 5 | d 14 |
|---|---|---|---|---|---|
| FC0 | 4.08 | 6.86^{a} | 10.42 | 8.41 | 8.00 |
| FC50 | 3.58 | 5.95^{ab} | 8.65 | 8.99 | 7.33 |
| FC100 | 3.85 | 5.70^{ab} | 9.28 | 8.01 | 7.27 |
| FC200 | 3.84 | 5.02^{b} | 9.35 | 8.31 | 6.98 |

* Time effect, P < 0.01; Block effect, P < 0.01; Treatment × Block, P = 0.083

### Example 2: Use of Fucosidase to Increase IgA Secretion Levels in Swine

IgA levels bound to the surface of fecal microbes are related to the luminal concentration, specificity, and avidity of IgA secreted across the intestinal epithelium. Low levels of IgA binding in weaned piglets can signify a delayed maturation of mucosal adaptive immunity in response to increasingly diverse signals from microbial and food antigens. In order to assess the maturation status of piglets receiving experimental feed preparations containing fucosidase enzyme, this Example measured the levels of IgA by immunolabeling fecal microbes and analyzing the bound fraction by flow cytometry.

### Materials and Methods

Fecal samples collected on days 0, 5, and 14 were collected fresh and stored frozen (−80° C.). Sampling days are defined as follows; [Day 0] collected after seven days on experimental feed regimens and before the first inoculation with ETEC, [Day 5] peak of the symptomatic period following ETEC challenge, [Day 14] End of the trial period where most animals have fully recovered from the effects of the ETEC challenge.

All fecal samples were thawed and approximately 100 mg of fecal matter was transferred to a well of a deep well assay plate containing 1.0 ml of PBS, 2 mM EDTA, 1% BSA. Plates were spun in a centrifuge for 2 minutes at 300×g to sediment particulate fecal matter, then 250 ul of the bacteria containing supernatant was transferred to a new plate containing PBS, 2 mM EDTA, 1% BSA. The resuspended fecal bacteria were pelleted by centrifugation at 5000×g for 10 minutes at 4° C. and the supernatant was aspirated, and the bacteria cell pellet was resuspended in 1.0 ml of PBS, 2 mM EDTA, 1% BSA for a second round of centrifugation, aspiration, and re-suspension as done in the previous step.

Twenty μl of the resuspended pellet was incubated with a 20 μl volume of a goat anti-swine IgA-FITC antibody (Bethyl Laboratories) and incubated on ice for 40 minutes. After incubation with anti-IgA antibodies 160 μl of PBS. 2 mM EDTA, 1% BSA containing a 1:2000 dilution SYTO 62 (Invitrogen) was added to the bacteria/antibody primary incubation in order to label the DNA containing bacterial cells with a fluorescent signal to serve as a triggering threshold to exclude small non bacteria debris in the sample from the flow cytometry analysis.

Flow cytometry was performed on an Acea NovoCyte flow cytometer and analyzed with NovoExpress software. An analysis gate was drawn to encompass cells with a green fluorescent emission signal coming from the FITC labeled anti-IgA antibody which also excluded the unbound cell fraction. An irrelevant goat antibody labeled with FITC was used to identify the boundary between non labeled and labeled cell populations. The mean fluorescent signal of the IgA bound population was used as a relative measure of IgA binding quality for each animal and at each timepoint. Statistical analysis and data plots were generated with GraphPad Prism 9.1.2.

### Results

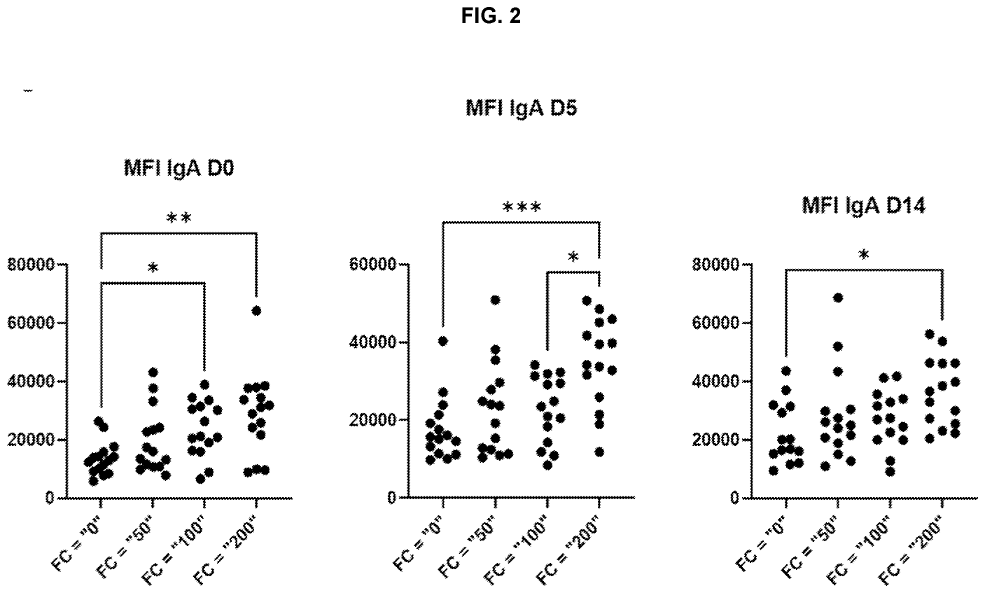

The results indicated that IgA levels on the surface of microbes from piglets receiving feed supplemented with fucosidase were significantly higher than animals receiving control feed. The observed increase in IgA measurements in response to fucosidase treatments was significant different between groups, (Welch's ANOVA DO P=0.0007. D5 P=0.0009. D14 P=0.02) and followed a linear dosing trend at all time points. (FIG. 2).

Additionally, fecal IgA measurements were found to be significantly increased by fucosidase feeding and correlated strongly with improved growth performance metrics. Table 3 summarizes the correlation between IgA levels at day 0 (DO), day 5 (D5), and day 14 (D14), and body weight (BW), average daily gains (ADG), and average daily feed intake (ADFI).

TABLE 3
Significant correlations between IgA secretion levels and growth
performance metrics were determined by calculating the Pearson
correlation statistics between variables. Pearson statistic
values that are statistically significant to at least one IgA
measurement are reported. Pearson r values that meet the 95%
confidence threshold are in bold and shaded grey.

| | IgA D 0 | IgA D 5 | IgA D 14 |
|---|---|---|---|
| IgA D 0 | 1 | 0.666629 | 0.477589 |
| IgA D 5 | 0.666629 | 1 | 0.549414 |
| IgA D 14 | 0.477589 | 0.549414 | 1 |
| BW D −7 | 0.247833 | 0.147308 | 0.156701 |
| BW D 0 | 0.38649 | 0.242635 | 0.245053 |
| BW D 7 | 0.34634 | 0.248851 | 0.317934 |
| BW D 14 | 0.284225 | 0.243128 | 0.288268 |
| ADG D −7-D 0 | 0.488809 | 0.326526 | 0.310961 |
| ADG D 0-D 7 | 0.128573 | 0.143918 | 0.279305 |
| AGD D 7-D 14 | 0.15476 | 0.187495 | 0.19571 |
| ADFI D −7-D 0 | 0.446842 | 0.328696 | 0.370738 |
| ADFI D 0-D 7 | 0.485302 | 0.253817 | 0.296862 |
| ADFI D 7-D 14 | 0.384618 | 0.258064 | 0.283146 |

IgA measured at DO correlated with all subsequent IgA measurements; D5 (r=0.6666) and D14 (r=0.4776), indicating that IgA levels obtained by the first week post weaning are largely persistent within individuals through ETEC challenge and recovery. Animals with higher body weight by DO positively correlated with IgA at DO (r=0.3865). Higher IgA values at day 0 correlated with ADFI (r=0.4468) and ADG (r=0.4888) over the first 7 days post weaning. While all animals experienced slowed growth through the ETEC infection period, animals with higher IgA continued to eat more feed throughout the infection and recovery phase following ETEC challenge. Since maternal secretory IgA from milk is not likely a significant source of IgA measured in samples by DO, these measurements represent the IgA secretory output of the piglet alone and are a marker of the maturation status of the piglet's mucosal immune system.

In summary, these results suggest that IgA secretion enhanced by fucosidase administered early after weaning correlates to stronger performance ahead of an ETEC challenge and was maintained at higher levels following resolution of ETEC symptoms. This indicates that long term performance gains and infection resilience were positively affected by feeding fucosidase.

### Example 3: Fucosidase Feeding Changes the Fecal Microbiome of Piglets

This Example shows how exogenous fucosidase affects microbial populations by analyzing the 16s ribosomal RNA sequences of microbes in fecal samples collected at various time points.

### Materials and Methods

Fecal samples were collected at the trial site on Day-7, Day 0, Day 5, and Day 14. Approximately 100 mg of freshly thawed fecal material was transferred to 96 well assays blocks and prepared for genomic DNA extraction using a MagAttract Microbial DNA Extraction Kit (Qiagen) according to manufacturer's protocol. Purified metagenomic DNA for 16S community sequencing was processed as follows for 16S Bacterial Population Sequencing: 21 of the metagenomic DNA was added to a PCR reaction along with 25 ul of ABI Universal TaqMan Reaction mix without UNG (ThermoFisher #4326614), 0.1 μl of each PCR primer at 100 μM (Illumina-V4-515F-RJ: TCGTCGGCAGCGTCAGATGTGTATAAGAGACAGGTGCCAGCMGCCGCGGTAA (SEQ ID NO:1)), Illumina-V4-806R-RJ: GTCTCGTGGGCTCGGAGATGTGTATAAGAGACAGGGACTACHVGGGTWTCTAAT (SEQ ID NO:2)) and 24.8 μl of Molecular Biology Grade water for a total volume of 50 μl.

Reactions were thermal cycled as follows; 10 min at 95 C followed by 35 cycles of 95 C 15 sec+55 C 30 sec+72 C for 2 min. Amplified reactions were purified using Ampure XP Magnetic Beads (Beckman Coulter A63881) as per manufacturer's instructions using the Agilent Bravo Automated Robotic Workstation. 21 of each amplicon pool is then indexed in a second PCR reaction using the same conditions as above with Illumina XT Index Primers (Illumina XT v2.0 #FC-131-2001-2004) for 15 cycles. Indexed amplicons are then pooled and purified with AmPure XP Magnetic Beads on the Agilent Bravo Automated Robotic Workstation. Pooled, indexed amplicons are quantitated using the Kapa Illumina Library Quantification Kit (KAPA #KK4835) as per manufacturer's instructions. Purified, quantitated, indexed, pools are loaded on the Illumina MiSeq at a final concentration of 8 pM along with 15% Illumina PhiX (Illumina FC-110-3001).

Sequencing was run for 2×250 Paired End cycles and the FASTQ files were exported for analysis. Sequence reads were assembled and aligned to 16s reference sequences from an internally collated reference database in order to assign taxonomic identities to the closest known species, sequence reads with no species match were assigned to separate taxonomic groupings labeled with the nearest species name with the % identity to the reference sequence. Microbial abundance changes due to treatment effects were analyzed using Kruskal-Wallis tests and Dunn's corrections for multiple comparisons.

### Results

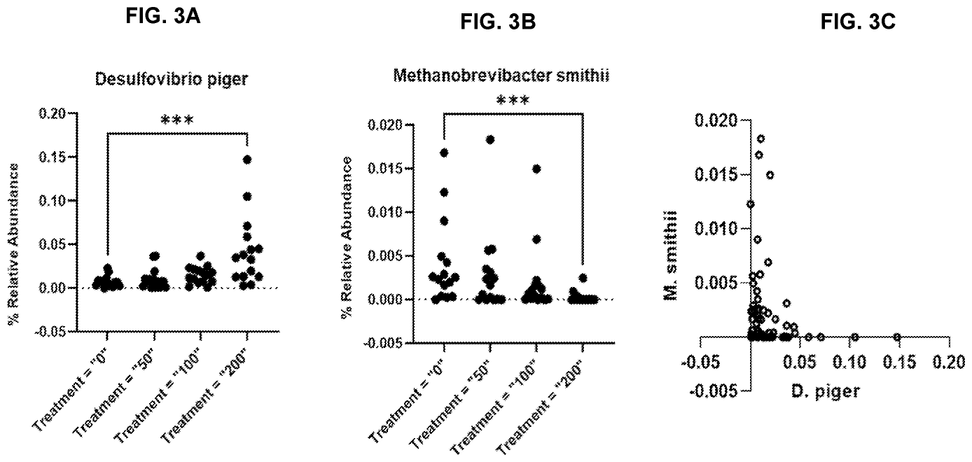

Microbial populations were significantly altered in response to treatment with fucosidase. Most notable were the concomitant shifts in the DO samples between the sulfate reducing bacteria (SRB) Desulfovibrio piger, and the methanogenic Archaea; Methanobrevibacter smithii (FIG. 3). M. smithii was ubiquitously abundant in all fecal samples collected at D-7. By DO, animals receiving fucosidase had significantly lower M. smithii levels compared to control animals. The drop in M. smithii correlated with increasing abundance of D. piger. The relationship between D. piger and M. smithii abundance patterns was highly anti-correlated ρ=−0.3217, P=0.01, (Table 4).

TABLE 4
Spearman correlation tables showing the Spearman statistic (ρ) and
corresponding P values between a) Methanobrevibacter smithii or
b) Desulfovibrio piger and performance measurements in individual
animals. % abundance, IgA, and blood cell levels are all from
the D 0 timepoints. Growth and feed intake measurements are
averaged over several time intervals defined here as (Week 1)
equal to D −7 through D 0, (Week 2) equal to D 0 through
D 7, and (Week 3) equal to Day 7 through Day 14

| | a) | | b) | |
|---|---|---|---|---|
| | Methanobrevibacter smithii | | Desulfovibrio_piger | |
| | ρ | p-value | ρ | p-value |
| MFI IgA | −0.4660 | 0.0002 | 0.3039 | 0.0183 |
| WBC (K/ul) | 0.0409 | 0.7563 | 0.0323 | 0.8062 |
| Abs Neutr (K/ul) | 0.0950 | 0.4702 | −0.0302 | 0.8190 |
| Abs Lymph (K/ul) | −0.0913 | 0.4879 | 0.2572 | 0.0473 |
| Abs Mono (K/ul) | −0.2253 | 0.0836 | −0.1110 | 0.3984 |
| Abs Eos (K/ul) | 0.0544 | 0.6795 | −0.1234 | 0.3475 |
| Abs Baso (K/ul) | 0.1934 | 0.1386 | −0.3464 | 0.0067 |
| ADG (Week 1) | −0.4974 | 0.0001 | 0.1878 | 0.1508 |
| ADG (Week 2) | −0.1493 | 0.2592 | −0.0053 | 0.9685 |
| ADG (Week 3) | −0.2090 | 0.1091 | 0.1944 | 0.1367 |
| ADFI (Week 1) | −0.4294 | 0.0006 | 0.0240 | 0.8558 |
| ADFI (Week 2) | −0.3755 | 0.0034 | 0.0380 | 0.7749 |
| ADFI (Week 3) | −0.4747 | 0.0002 | 0.1590 | 0.2331 |
| D_piger | −0.3217 | 0.0122 | | |
| M_smithii | | [symbol] | −0.3217 | 0.0122 |

There were inverse correlative relationships with IgA measurements where M. smithii showed negative correlations ρ=−0.466, ρ=0.0002, and D. piger showed positive correlations ρ=0.3039, ρ=0.018. D. piger also showed a positive spearman correlation with lymphocytes and a negative correlation with basophils (Table 4). Methanogen abundance on DO was also anti-correlated with ADG in the first week following weaning and was associated with reduced average daily feed intake over all the trial time intervals.

In summary, taken together these data show that fucosidase feeding led to M. smithii depletion in the gut, D. piger enrichment in the gut, and was associated with favorable immune and growth performance metrics.

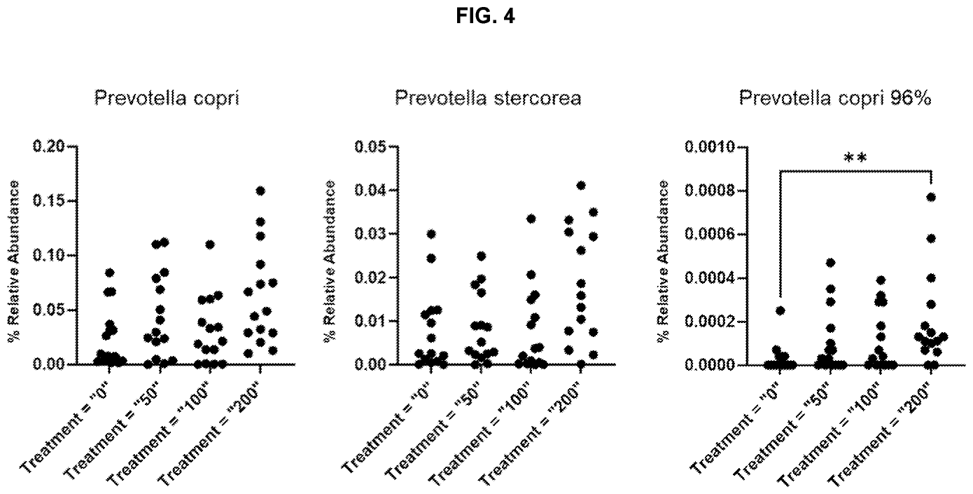

Moreover, in addition to alterations in methanogenic and sulfate reducing bacteria, fucosidase treatment also altered the abundance of species within the genus Prevotella. FIG. 4 shows the relative abundance of P. copri and closely related species including P. stercorea by treatment group. Increasing abundance of Prevotella in response to fucosidase treatment indicates efficient transitional adaptation and diversification of intestinal microbiota from maternal milk to a grain-based diet.

### Example 4: Fucosidase Treatment Influences Lymphocyte and Neutrophil Levels

In this Example, lymphocyte and neutrophil levels in fucosidase treated swine are examined compared to control.

### Materials and Methods

Levels of white blood cells were measured in samples taken at the beginning of the trial (day −7), after the first week of receiving experimental diets (day 0), and several points following challenge with ETEC, days 2, 5, and 14. (Complete Blood Count) CBC analysis was performed at the Comparative Pathology Laboratory, University of California, Davis. Whole blood samples were collected from the jugular vein of all pigs with EDTA and used to measure total and differential blood cell counts by A multiparameter, automated programmed hematology analyzer (Drew/ERBA Scientific 950 FS Hematological Analyzer, Drew Scientific Inc., Miami, FL). CBC levels were expressed as absolute counts (1000 cells/ul blood), or as a percentage of total white blood cells. Treatment effects were analyzed for significant differences using one-way ANOVA. In addition, neutrophil/lymphocyte ratios (NLR) were calculated. NLR measurements were determined to be non-gaussian distributions and were analyzed for significance using a non-parametric Kruskal-Wallis test. Tests for linear trends by treatment dose groups were conducted within the One-Way ANOVA analysis package in GraphPad Prism 9.1.2.

### Results

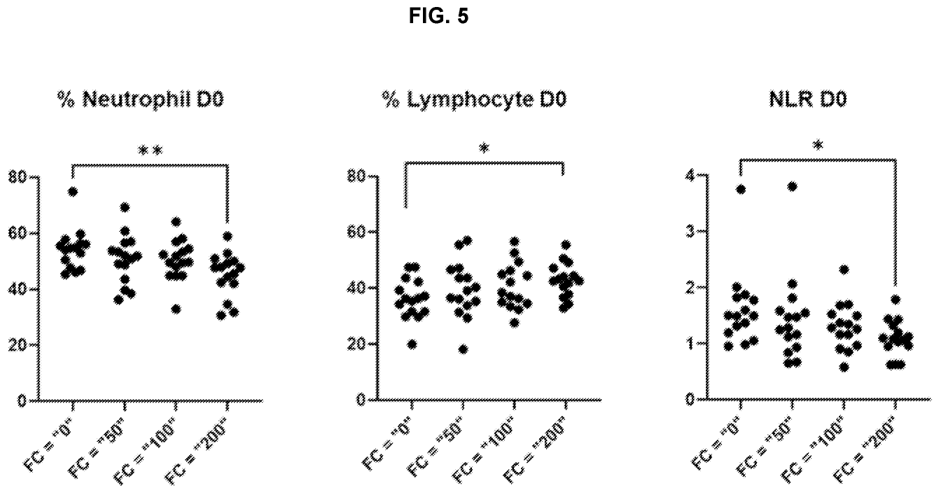

It was found that the percentage of neutrophil in animals receiving fucosidase was significantly lower (ANOVA P=0.02) whereas lymphocytes had a significant upward linear trend with dose (P=0.025), ANOVA (P=0.15). The NLR was also significantly lower (Kruskal-Wallis P=0.045; FIG. 5). Neutrophil and lymphocyte levels are influenced by numerous factors that include cytokines, microbial metabolites, cortisol levels, and catecholamines. Elevated NLR values may predict poor clinical outcomes to infections in humans. In the context of this study and without being bound to theory, alteration of neutrophil and lymphocyte values in the blood of animals receiving fucosidase may signify improved compartmentalization of numerous signaling molecules that are abundant in the gut from reaching systemic signaling receptors.

### Example 5: Effects of Fucosidase Supplementation in Weaned Piglets

The goal of this Example was to investigate the effect of exogenous fucosidase supplementation on growth performance, immune response and microbiome shift in weaned piglets.

A total of 216 weaned piglets (n=12, 1:1 male female), 6-7 kg BW were group housed (6 piglets per pen) from the day of weaning and randomly assigned to the 3 dietary treatments. Piglets were fed the diets with enzymes from day 0 (weaning) until day 21 and from d 22 to day 42 all pigs were fed the control diets without enzyme.

Before the start of the study on day 0 (weaning day), 10 piglets were bled for blood collection (whole blood and serum). Then they were euthanized to collect digesta (jejunum, ileum and caecum) and tissue samples (ileum and caecum).

Twelve piglets from each treatment (1/pen) were bled on d 15 and d 29 to collect blood (whole blood and plasma), and then were euthanized to collect digesta (jejunum, ileum and caecum) and tissue samples (ileum and caecum). Before euthanization, pigs were anesthetized with a mixture of 50 mg ketamine, and 50 mg xylazine (1:1) by intramuscular injection. After anesthesia, intracardiac injection with 78 mg sodium pentobarbital per 1 kg of BW were used to euthanize pigs.

Body weight and feed intake were recorded weekly from day 0 (weaning) until day 42.

The piglets were given ad libitum access to feed and water. A 16 hr light and 8 hr dark lighting program were followed. Room temperature is maintained at 30° C. during week 1 and gradually reduced to 24° C. by week 6. The experimental diets offered to the piglets throughout the 21-day period was as below
A) Control diet¹ based on corn, wheat and soybean meal
B) Control diet supplemented with 100 ppm FE (uncoated-WGW)
C) Control diet supplemented with 100 ppm FE (coated-Eudragit®) 1 EU commercial type diet. All diets will be provided as meal form.

From day 22 to day 42, all piglets are given the un-supplemented control diet (Diet A).

### Response Criteria and Sampling

Diarrhea scoring: During the experiment, scores for diarrhea were assigned twice daily from day 0 to d 14. The diarrhea score was assessed visually by 2 independent evaluators, using a 5-scale system (1=normal feces, 2=moist feces, 3=mild diarrhea, 4=severe diarrhea, and 5=watery diarrhea).

Growth performance: Body weight was recorded weekly, and average daily weight gain calculated afterwards. Feed intake per pen, and the feed left overs were recorded weekly, and average daily feed intake calculated afterwards.

Complete blood count analysis: Blood samples were collected from the jugular vein of all pigs with EDTA on day 0, 15 and 29 to yield whole blood. Whole blood samples were used to measure total and differential blood cell counts using a multiparameter, automated programmed hematology analyzer.

Serum samples: Blood samples were collected from the jugular vein of all pigs to separate serum on day 0, 15 and 29. Serum samples were analyzed for pro-inflammatory cytokine IL-10, IL-6, IL-10, TNF, IL-12), and acute phase proteins (C-reactive protein and haptoglobin) using commercial ELISA kits.

Gut tissue samples: Sections of Jejunum, ileal and caecum were collected on day 0, 15 and 29 and stored at −80° C. for further use for gene expression (Tight junction, mucin and F4/F18 receptor).

Digesta samples for enzyme activity: Digesta samples from stomach, mid jejunum, Ileum were collected on day 15 to determine the enzyme recovery.

Digesta samples for microbiome analysis: Digesta samples from ileal and caecal were collected on day 0, 15 and 29 for analysis of microbiome.

Feces and digesta: Stool was quickly frozen till use. Frozen stool was rehydrated in PBS and suspended by vortexing. After centrifugation the supernatant was collected for ELISA. For digesta, it was rinsed by PBS and filtered. The supernatant was collected for ELISA.

ELISA: SIgA was measured by ELISA (total SIgA). All ELISA kits were bought from MyBiosource and the experiments followed supplier's instruction. The ELISA assay was sandwich ELISA. Each sample was performed with duplicates.

### Results

From day 0 to 20, there were 0 cases of mortality observed in pigs fed diets supplemented with fucosidase. In stark contrast, 5 animals in the non-supplemented control group died in the first three weeks of the trial. Once fucosidase supplementation ended, mortality was observed in pigs that had been in both of the experimental groups, with two pigs dying in the WCW group and 4 pigs dying in the coated group. Mortality data is shown in Table 5. Overall mortality was 4.63% for the control group, 1.85% for the WGW group, and 3.7% for the coated group.

TABLE 5
Mortality data in fucosidase supplementation trial

| | Days on | Day 0, | Day 14, | Day 21, | Day 28, | Necropsy |
|---|---|---|---|---|---|---|
| Treatment | trial | kg | kg | kg | kg | Findings |
| Control | 11 | 7.28 | 7.58 | | | Inflammation GIT, |
| | | | | | | oedema colon |
| | 13 | 6.56 | | 7.50 | | Inflammation GIT, |
| | | | | | | oedema colon |
| | 14 | 7.18 | 8.52 | | | colibacillosis |
| | 14 | 5.90 | 7.44 | | | colibacillosis |
| | 22 | 5.38 | 5.79 | | | Meningitis |
| WGW | 24 | 5.12 | | | 8.20 | Meningitis |
| | 25 | 4.78 | | | 8.10 | Meningitis |
| Coated | 24 | 5.18 | | | 8.05 | Inflammation, |
| | | | | | | oedema colon |
| | 25 | 5.02 | | | 10.2 | oedema colon |
| | 25 | 4.94 | | | 9.00 | oedema colon |
| | 21 | 4.56 | | 8.10 | | oedema colon |

A multivariate latent class model (LCA) statistical analysis was performed on the FCR data.

A test of treatment differences by level for variables was performed to permit determination of which individual variables were up- and down-regulated by treatment. In the cells of Table 6 are Z-scores for information carriers, and these are interpreted by the sign (the direction of the effect) and the size (the strength such that higher absolute value is more significant). Significant effects at level 5% by a 2-sided test (i.e. an absolute Z-score>1.96) are indicated by colour codes (shaded=positive score for information carrier).

TABLE 6
Feed conversion ratio (FCR) among treatment
groups in fucosidase supplementation trial

| | | Level | | | | | | |
|---|---|---|---|---|---|---|---|---|
| _STRATA | _NAME_{—} | trt_1 | trt_2 | trt_3 | trt1_2 | trt1_3 | trt2_3 | trt1_23 |
| AUC | FCR | 2.04 | −1.39 | −0.65 | 1.99 | 1.55 | −0.43 | 2.04 |
| D21_0 | FCR | 2.13 | −0.85 | −1.28 | 1.72 | 1.97 | 0.25 | 2.13 |
| D42_21 | FCR | 0.04 | −0.89 | 0.85 | 0.53 | −0.47 | −1.01 | 0.04 |

“trt_1” is contrast (Trt=1=Control) vs. the average of (Trt=2=WGW) and (Trt=3=Coated).
“trt_2” is contrast (Trt=2=WGW) vs. the average of (Trt=1=Control) and (Trt=3=Coated).
“trt_3” is contrast (Trt=3=Coated) vs. the average of (Trt=1=Control) and (Trt=2=WGW).
“trt1_2” is the pairwise contrast (Trt=1=Control) vs. (Trt=2=WGW).
“trt1_3” is the pairwise contrast (Trt=1=Control) vs. (Trt=3=Coated).
“trt2_3” is the pairwise contrast (Trt=2=WGW) vs. (Trt=3=Coated).
“trt1_23” is contrast (Trt=1=Control) vs. the average of (Trt=2=WGW) and (Trt=3=Coated; Essentially the same as “trt_1”).
AUC is area under curve and is the statistics for FCR for the total period of the study, day 0-42.
D21_0 is the statistics for FCR after the first 21 days (=the period the pigs were fed the fucosidase enzyme)
D42_21 is the statistics for FCR between 21 and 42 days (=the period in which the pigs were fed the control diet without fucosidase enzyme).

For FCR, the optimal direction of the variable is low, then optimality is successful if “trt1_23” is positive (>1.96, “shaded” coloured).

Thus, for FCR (where a lower FCR is optimal/preferred) a beneficial effect of treatment vs control for _STRATA_=AUC and _STRATA_=D21_0 is observed, but not for _STRATA_=D42_21.

The trial therefore demonstrates that feeding 100 ppm coated fucosidase gave a significant improvement in FCR for the period of feeding the enzyme (day 0-21) and there was a trending positive effect of feeding WGW formulated fucosidase (day 0-21).

When measured over the total trial period (day 0-42) was is a significant improvement in FCR for feeding WGW formulated fucosidase as well as for the average of the two fucosidase enzyme formulations (WGW plus coated), although the enzyme wasn't fed for day 21-42.

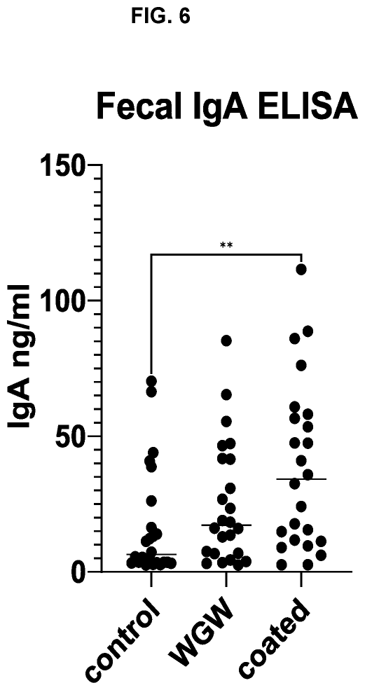

As shown in FIG. 6, in fucosidase treated piglet in feces, there was a significantly higher amount of total SIgA compared to the control (Tr3: 38.4±6.2 ng/ml vs control: 16.8±4.1 ng/ml, p<0.01). Numerical increase of SIgA was observed in ileum content in Tr3 treated piglets (day 15, 11.5±1.6 ng/ml in Tr3 vs 10.7±1.7 ng/ml in control; day 30, 10.4±2.7 ng/ml in Tr3 vs 8.8±1.3 ng/ml in control; day 42, 11.3±2.9 ng/ml in Tr3 vs 9.4±2.5 ng/ml in control). This represents a 7.5%, 18.2% and 20.2% increase in Tr3 treated piglets on day 15, 30 and 42 respectively. The upregulation of antibody is class specific as only sIgA, but not IgG, was influenced.

SEQUENCES

GDGDTSKDDWLWYKQPASQTDATATAGGNYGNPDNNRWQQTTLPFGNGK
IGGTVWGEVSRERVTFNEETLWTGGPGSSTSYNGGNNETKGQNGATLRA
LNKQLANGAETVNPGNLTGGENAAEQGNYLNWGDIYLDYGENDTTVTEY
RRDLNLSKGKADVTFKHDGVTYTREYFASNPDNVMVARLTASKAGKLNF
NVSMPTNTNYSKTGETTTVKGDTLTVKGALGNNGLLYNSQIKVVLDNGE
GTLSEGSDGASLKVSDAKAVTLYIAAATDYKQKYPSYRTGETAAEVNTR
VAKVVQDAANKGYTAVKKAHIDDHSAIYDRVKIDLGQSGHSSDGAVATD
ALLKAYQRGSATTAQKRELETLVYKYGRYLTIGSSRENSQLPSNLQGIW
SVTAGDNAHGNTPWGSDFHMNVNLQMNYWPTYSANMGELAEPLIEYVEG
LVKPGRVTAKVYAGAETTNPETTPIGEGEGYMAHTENTAYGWTAPGQSF
SWGWSPAAVPWILQNVYEAYEYSGDPALLDRVYALLKEESHFYVNYMLH
KAGSSSGDRLTTGVAYSPEQGPLGTDGNTYESSLVWQMLNDAIEAAKAK
GDPDGLVGNTTDCSADNWAKNDSGNFTDANANRSWSCAKSLLKPIEVGD
SGQIKEWYFEGALGKKKDGSTISGYQADNQHRHMSHLLGLFPGDLITID
NSEYMDAAKTSLRYRCFKGNVLQSNTGWAIGQRINSWARTGDGNTTYQL
VELQLKNAMYANLFDYHAPFQIDGNFGNTSGVDEMLLQSNSTFTDTAGK
KYVNYTNILPALPDAWAGGSVSGLVARGNFTVGTTWKNGKATEVRLTSN
KGKQAAVKITAGGAQNYEVKNGDTAVNAKVVTNADGASLLVFDTTAGTT
YTITKK (SEQ ID NO: 3)

1. A method for improving gut health in an animal comprising administering to the animal an effective amount of a glycoside hydrolase capable of removing at least one alpha-1,2-L-fucose moiety from an intestinal mucin layer.

2. The method of claim 1, wherein improving gut health comprises one or more of a) promoting growth of one or more commensal intestinal bacterial; b) decreasing growth of one or more methanogenic archaea; c) increasing the quantity of intestinal IgA; d) decreasing the quantity of intestinal neutrophil levels; e) increasing average daily feed intake (ADFI) of the animal; f) decreasing mortality; and/or g) improving feed conversion ratio (FCR).

3. The method of claim 1, wherein the commensal bacteria comprise Prevotella spp. and/or Megasphaera spp.

4. The method of claim 1, wherein the methanogenic archaea comprises Methanobrevibacter spp.

5. The method of claim 4, wherein the methanogenic archaea comprises M. smithii.

6. The method of claim 1, wherein the glycoside hydrolase is an alpha-L-1,2 fucosidase.

7. The method of claim 6, wherein the alpha-L-fucosidase is selected from the group consisting of glycoside hydrolase family 95 (GH95) and glycoside hydrolase family 29 (GH 29).

8. The method of claim 1, wherein the method further comprises administering to the animal an effective amount of at least one direct fed microbial.

9. The method of claim 1, wherein the method further comprises administering to the animal an effective amount of one or more additional enzyme selected from the group consisting of protease, xylanase, beta-glucanase, phytase, and amylase.

10. The method of claim 1, wherein (i) the alpha-L-1,2 fucosidase and/or additional enzyme is encapsulated; (ii) the alpha-L-1.2 fucosidase and/or the direct fed microbial and/or the additional enzyme are administered in an animal feed or a premix; and/or (iii) the alpha-L-1,2 fucosidase and/or additional enzyme is in the form of a granule.

11-12. (canceled)

13. The method of claim 1, wherein the animal is swine.

14-15. (canceled)

16. The method of claim 1, wherein the glycoside hydrolase capable of removing at least one alpha-1,2-L-fucose moiety from an intestinal mucin layer is not administered for treatment or prevention of intestinal pathogenic infection and/or diarrhea.

17. The method of claim 1, wherein the glycoside hydrolase capable of removing at least one alpha-1,2-L-fucose moiety from an intestinal mucin layer is administered for at least 3 weeks.

18. The method of claim 2, wherein the intestinal IgA is bound to fecal microbes.

19. A method for decreasing methane emissions in an animal comprising administering to the animal an effective amount of a glycoside hydrolase capable of removing at least one alpha-1,2-L-fucose moiety from an intestinal mucin layer.

20. The method of claim 19, wherein the decreased methane emissions result from decreased growth of one or more methanogenic archaea in the intestinal tract if the animal.

21. The method if claim 19, wherein the methanogenic archaea comprises Methanobrevibacter spp.

22. The method of claim 19, wherein the methanogenic archaea comprises M. smithii.

23. The method of claim 19, wherein the glycoside hydrolase is an alpha-L-1,2 fucosidase.

24. The method of claim 23, wherein the alpha-L-1,2 fucosidase is selected from the group consisting of glycoside hydrolase family 95 (GH95) and glycoside hydrolase family 29 (GH 29).

25. The method of claim 19, wherein the alpha-L-1,2 fucosidase is (i) encapsulated; (ii) in an animal feed or a premix; (iii) and/or in the form of a granule.

26-27. (canceled)

28. The method of claim 19, wherein the animal is swine.

29-30. (canceled)

31. The method of claim 19, wherein the glycoside hydrolase capable of removing at least one alpha-1,2-L-fucose moiety from an intestinal mucin layer is administered for at least 3 weeks.
